(19) United States
(12) Patent Application Publication
(10) Pub. No.: US 2026/0155134 A1
(43) Pub. Date: Jun. 4, 2026

(54) GENERATIVE SUGGESTION CHIPS FOR ENHANCED CHATBOT CONVERSATIONS

(71) Applicant: GOOGLE LLC, Mountain View, CA (US)

(72) Inventors: Yoav Tzur, Tel Aviv (IL); Ran El Manor, Savyon (IL); Liran Peretz, Tel Mond (IL)

(21) Appl. No.: 19/055,192

(22) Filed: Feb. 17, 2025

Related U.S. Application Data
(60) Provisional application No. 63/727,511, filed on Dec. 3, 2024.

(51) Int. Cl. G10L 13/027; G10L 13/047; G10L 15/22; G10L 15/30

(52) U.S. Cl. CPC G10L 13/027; G10L 13/047; G10L 15/22; G10L 15/30

(57) ABSTRACT

Implementations disclosed herein relate to dynamically generating suggestion chip(s) during a conversation between a chatbot, that is engaged in the conversation on behalf of a user, and an additional user. During the conversation, processor(s) of a system can: receive an initial portion of a spoken utterance of the additional user; generate, based on processing at least the initial portion of the spoken utterance, initial suggestion chip(s) that are each associated with a corresponding initial suggestion to respond to the spoken utterance; receive a subsequent portion of the spoken utterance; and determine, based on processing the subsequent portion of the spoken utterance, whether to cause the initial suggestion chip(s) to be rendered at a client device of the user. If rendered, the initial suggestion chip(s) can guide the chatbot's response. Otherwise, the system can generate subsequent suggestion chip(s) that are based on the entirety of the spoken utterance.

### BACKGROUND

Humans (also referred to herein as “users”) may engage in human-to-computer dialogs with interactive software applications referred to as “chatbots,” “voice bots”, “automated assistants”, “interactive personal assistants,” “intelligent personal assistants,” “conversational agents,” etc. via a variety of computing devices. As one example, these chatbots may correspond to a machine learning model or a combination of different machine learning models, and may be utilized to perform various tasks on behalf of users. For instance, some of these chatbots can conduct conversations with various users to perform action(s) or task(s) on behalf of users and/or on behalf of entities associated with the users. In some of these instances, the conversations can include voice-based conversations, such as conversations conducted locally at a computing device, conducted over multiple computing devices via a telephonic network, or other voice-based scenarios.

Notably, not only can some of these chatbots initiate these conversations to perform the action(s) or task(s), but some of these chatbots can also respond to other users that initiate these conversations. As one example, these chatbots can answer incoming telephone calls directed to a given user and engage in these conversations with an additional user that initiated an incoming telephone calls However, functionality of these chatbots is generally limited to ascertaining an identity of the additional user that initiated incoming telephone call, ascertaining a certain reason why the additional user initiated incoming telephone call, and/or other general call screening functionalities. Put another way, these chatbots that can answer incoming telephone calls directed to the given user are generally not capable of performing more than rudimentary action(s) or task(s).

As a result, these chatbots generally request that the user join the telephone calls and take over the conversations from these chatbots since they are not capable of not capable of performing the action(s) or task(s) on behalf of the given user and/or provide suggestion chip(s) to request input from the given user to drive the conversation. In situations where these chatbots provide suggestion chip(s) to request the input from the given user to drive the conversation, these suggestion chip(s) can be based on a given spoken utterance of the additional user. Put another way, these suggestion chip(s) can be tailored to the incoming telephone call in the above example. However, these suggestion chip(s) are usually not generated until the additional user has completed the given spoken utterance, which introduces latency in generating these suggestion chip(s), thereby prolonging these conversations and wasting computational and/or network resources. Further, a response to the given spoken utterance is usually not rendered as part of these conversations until the given user selects one of these suggestion chip(s), thereby further prolonging these conversations and wasting additional computational and/or network resources.

### SUMMARY

Implementations disclosed herein are directed to dynamically generating suggestion chip(s) during a conversation between a chatbot, that is engaged in the conversation on behalf of a user, and an additional user. For example, processor(s) of a system can cause the chatbot to engage in the conversation with the additional user during a telephone call (or via other communication channels), and on behalf of the user. During the telephone call, the processor(s) can receive an initial portion of audio data capturing an initial portion of a spoken utterance of the additional user. The processor(s) can generate initial suggestion chip(s) based on processing the initial portion of the spoken utterance and using the chatbot, where each of the initial suggestion chip(s) is associated with a corresponding initial suggestion to respond to the spoken utterance. Further, the processor(s) can receive a subsequent portion of audio data capturing a subsequent portion of the spoken utterance, and determine whether to render the initial suggestion chip(s) at a client device of the user, and in response to determining to render the initial suggestion chip(s), cause the initial suggestion chip(s) to be rendered and cause additional audio data capturing synthesized speech, based on a corresponding initial suggestion for a given initial suggestion chip of the initial suggestion chip(s), to be audibly rendered at an additional client device of the additional user. Moreover, and in response to determining not to render the initial suggestion chip(s), the processor(s) can generate subsequent suggestion chips based on processing at least the subsequent portion of the spoken utterance and using the chatbot, where each of the subsequent suggestion chip(s) is associated with a corresponding subsequent suggestion to respond to the spoken utterance, and cause the subsequent suggestion chip(s) to be rendered and cause additional audio data capturing synthesized speech, based on a corresponding subsequent suggestion for a given subsequent suggestion chip of the subsequent suggestion chip(s), to be audibly rendered at an additional client device of the additional user.

In some implementations, the additional audio data capturing the synthesized speech can be audibly rendered at the additional client device of the additional user in response to receiving, from the user, an indication of a selection of the given initial suggestion chip or the given subsequent suggestion chip. For example, the selection of the given initial suggestion chip or the given subsequent suggestion chip can be based on user input directed to the client device of the user, such as a selection provided using touch input or spoken input.

In additional or alternative implementations, the additional audio data capturing the synthesized speech can be audibly rendered at the additional client device of the additional user in response to determining that a threshold duration of time has lapsed since the initial suggestion chip(s) and/or the subsequent suggestion chip(s) were rendered at the client device of the user, and the given initial or suggestion chip or the given subsequent suggestion chip can correspond to a highest ranking one of the suggestion chip(s) that is rendered. In some versions of those implementations, the threshold duration of time can be general to a plurality of additional users, including the additional user, whereas, in other versions of those implementations, the threshold duration of time can be specific to the additional user. For instance, in situations where the threshold duration of time is general to the plurality of additional users, the threshold duration of time can be defined by a developer that is associated with the chatbot or the user. Also, for instance, in situations where the threshold duration of time is specific to the additional user, the threshold duration of time can be based on a speaking pace of the spoken utterance of the additional user, a historical speaking pace of the additional user, a mood of the additional user, and/or other factors.

Notably, various implementations disclosed herein can mitigate and/or eliminate various drawbacks with current techniques. For example, by generating the initial suggestion chip(s) based on the initial portion of the spoken utterance of the additional user, the system can predict potential responses to the spoken utterance and present options to the user before the spoken utterance is complete and/or immediately upon the spoken utterance being contemplated, thereby reducing latency and concluding the conversation in a more quick and efficient manner. As another example, the system's ability to automatically select a suggestion chip after a time delay, based on factors like the user's historical speaking pace, ensures a timely response even if the user doesn't manually select an option, optimizing resource utilization. As another example, the system's ability to generate subsequent suggestion chips based on the entire utterance if the initial prediction is inaccurate ensures that the chatbot's response is always relevant and accurate from an objective standpoint.

As a non-limiting example of some implementations disclosed herein, consider a user, John, using a chatbot to manage his schedule. An incoming call from an additional user, Frank, is answered by the chatbot. In this example, Frank can begin speaking: “Hi John, I'd like to schedule a meeting sometime next week to discuss the marketing campaign . . . I'm available Tuesday afternoon or Wednesday morning.” The chatbot, having processed the initial portion of Frank's utterance (“Hi John, I'd like to schedule a meeting sometime next week”), can generate two suggestion chips: “Suggest Tuesday afternoon” and “Suggest Wednesday morning.” The chatbot then continues listening. Once Frank finishes his spoken utterance, the chatbot determines that the initial suggestion chips are still relevant. Consequently, the chatbot renders these chips on John's phone screen. Accordingly, if John selects “Suggest Tuesday afternoon”, the chatbot then transmits synthesized speech to Frank confirming the meeting time, completing the scheduling task efficiently.

Notably, the chatbot described herein can be a generative model based chatbot. Accordingly, not only can the chatbot take into account spoken utterances received during a given conversation, but can also take into account other contextual information of the user and/or the additional user to generate the initial suggestion chip(s) and/or the subsequent suggestion chip(s). For example, contextual information associated with the user and/or the additional user can include electronic documents shared between the user and the additional user, calendar information for the user and/or the additional user, and/or other contextual information. Continuing with the above example, the initial suggestion chip(s) can be based on John and Frank's calendars that indicate they both have availability for Tuesday afternoon and Wednesday morning, which is why those days and time periods are included in the initial suggestion chip(s). However, if Frank continued speaking and indicated that he would instead like to meet sometime the following week (e.g., instead of next week), the chatbot could generate two (or more) new suggestion chips based on their respective calendar information of John and Frank for the following week.

The above description is provided as an overview of only some implementations disclosed herein. Those implementations, and other implementations, are described in additional detail herein.

### BRIEF DESCRIPTION OF THE DRAWINGS

FIG. 1 depicts a block diagram of an example environment that demonstrates various aspects of the present disclosure, and in which implementations disclosed herein can be implemented.

FIG. 2 depicts a flowchart illustrating an example method of supervised fine-tuning (SFT) of a chatbot to enable generation of suggestion chip(s) during a telephone call, in accordance with various implementations.

FIG. 3 depicts a flowchart illustrating an example method of performing reinforcement learning from human feedback (RLHF) for a chatbot to enable generation of suggestion chip(s) during a telephone call, in accordance with various implementations.

FIG. 4 depicts a flowchart illustrating an example method of causing a chatbot to engage in a conversation during a telephone call and generate suggestion chip(s) during the telephone call, in accordance with various implementations.

FIG. 5 depicts a non-limiting example of generating initial suggestion chip(s) based on an initial portion of a spoken utterance received during a telephone call and determining to render the initial suggestion chip(s) based on a subsequent portion of the spoken utterance received during the telephone call, in accordance with various implementations.

FIG. 6 depicts a non-limiting example of generating initial suggestion chip(s) based on an initial portion of a spoken utterance received during a telephone call and determining to generate and render subsequent suggestion chip(s) based on a subsequent portion of the spoken utterance received during the telephone call, in accordance with various implementations.

FIG. 7 depicts an example architecture of a computing device, in accordance with various implementations.

### DETAILED DESCRIPTION

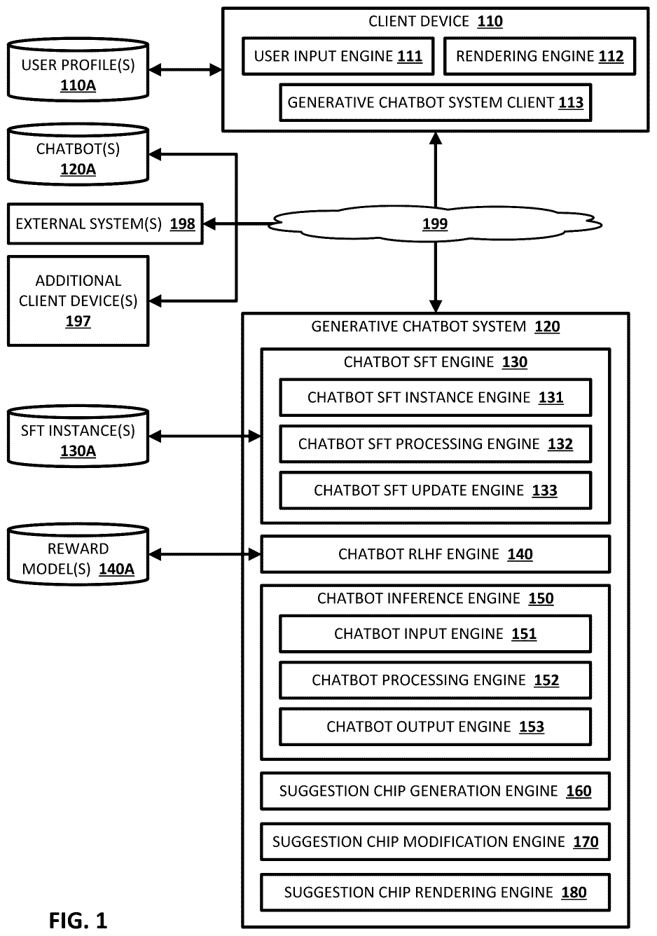

Turning now to FIG. 1, a block diagram of an example environment that demonstrates various aspects of the present disclosure, and in which implementations disclosed herein can be implemented is depicted. A client device 110 is illustrated in FIG. 1, and includes, in various implementations, user input engine 120, rendering engine 130, on-device machine learning (ML) model engine 140, and personalized chatbot engine 150. The client device 110 can be, for example, a standalone device (e.g., having microphone(s), vision component(s), speaker(s), display(s), and/or other user interface components), a laptop, a desktop computer, a tablet, a wearable computing device, a vehicular computing device, and/or any other client device capable of implementing the personalized chatbot engine 150.

Turning now to FIG. 1, a block diagram of an example environment that demonstrates various aspects of the present disclosure, and in which implementations disclosed herein can be implemented is depicted. A client device 110 is illustrated in FIG. 1, and includes, in various implementations, a user input engine 111, a rendering engine 112, and a generative chatbot system client 113. The client device 110 may be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, a video game console, and/or a wearable apparatus of the user that includes a computing device (e.g., a watch of the user having a computing device, glasses of the user having a computing device, a virtual or augmented reality computing device, etc.). Additional and/or alternative client devices may be provided.

The user input engine 111 can detect various types of user input at the client device 110. In some examples, the user input detected at the client device 110 can include spoken utterance(s) of a human user of the client device 110 that is detected via microphone(s) of the client device 110. In these examples, the microphone(s) of the client device 110 can generate audio data that captures the spoken utterance(s). In other examples, the user input detected at the client device 110 can include touch input of a human user of the client device 110 that is detected via user interface input device(s) (e.g., touch sensitive display(s)) of the client device 110, and/or typed input detected via user interface input device(s) (e.g., touch sensitive display(s) and/or keyboard(s)) of the client device 110. In these examples, the user interface input device(s) of the client device 110 can generate textual data that captures the touch input and/or the typed input. In other examples, the user input detected at the client device 110 can include vision-based input of a human user of the client device 110 that is detected via vision component(s) (e.g., camera(s)) of the client device 110.

The rendering engine 112 can cause content and/or other output to be visually rendered for presentation to the user at the client device 110 (e.g., via a touch sensitive display or other user interface output device(s)) and/or audibly rendered for presentation to the user at the client device 110 (e.g., via speaker(s) or other user interface output device(s)). The content and/or other output can include, for example, a transcript of a conversation between a user of the client device 110 and an automated assistant executing at least in part at the client device 110, an indication of actions to be performed by an automated assistant executing at least in part at the client device 110, notifications, selectable graphical elements, and/or any other content and/or output described herein.

The client device 110 is illustrated in FIG. 1 as communicatively coupled to a generative chatbot system 120 over one or more networks 199 (e.g., any combination of WiFi, Bluetooth, or other local area networks (LANs); ethernet, the Internet, or other wide area networks (WANs); public switched telephone networks (PTSNs), voice over internet protocol (VOIP) and/or telephonic networks; and/or any other wired or wireless networks). The generative chatbot system 120 can be implemented by, for example, a high-performance server, a cluster of high-performance servers, and/or any other computing device that is remote from the client device 110. The generative chatbot system 120 includes, in various implementations, a chatbot supervised fine-tuning (SFT) engine 130, a chatbot reinforcement learning from human feedback (RLHF) engine 140, a chatbot inference engine 150, a suggestion chip generation engine 160, a suggestion chip modification engine 170, and a suggestion chip rendering engine 180. The chatbot SFT engine 130 can include various sub-engines, such as a chatbot SFT instance engine 131, a chatbot SFT training engine 132, and a chatbot SFT update engine 133. Further, the chatbot inference engine 150 can include various sub-engines, such as a chatbot input engine 151, a chatbot processing engine 152, and a chatbot output engine 153. Although FIG. 1 is depicted with respect to certain engines and sub-engines, it should be understood that is for the sake of example and is not meant to be limiting. For example, one or more of the engines and/or sub-engines depicted in FIG. 1 can be combined and/or omitted.

The client device 110 and/or the generative chatbot system 120 can access various databases and/or systems. For instance, the client device 110 can access user profile(s) database 110A that stores user profile data as described herein, chatbot(s) database 120A that stores one or more chatbots as described herein, SFT instance(s) database 130A that stores SFT instances for performing SFT on one or more of the chatbots stored in the chatbot(s) database 120A, and/or reward model(s) database 140A that stores one or more rewards models for utilization in RLHF for one or more of the chatbots stored in the chatbot(s) database 120A. Further, the client device 110 and/or the generative chatbot system 120 can interact with one or more additional client devices 197 (associated with the user of the client device 110 and/or additional users that are in addition to the user of the client device 110) and/or one or more external systems 198 as described herein. However, in some implementations, the generative chatbot system 120 may not have access to the user profile(s) database 110A (e.g., when the generative chatbot system 120 is implemented remotely from the client device 110). Moreover, the generative content system 120 can also access chatbot(s) database 120A that stores one or more chatbots as described herein, SFT instance(s) database 130A that stores SFT instances for performing SFT on one or more of the chatbots stored in the chatbot(s) database 120A, and/or reward model(s) database 140A that stores one or more rewards models for utilization in RLHF for one or more of the chatbots stored in the chatbot(s) database 120A. Although FIG. 1 is depicted with respect to certain databases and systems, it should be understood that is for the sake of example and is not meant to be limiting. For example, one or more of the databases and/or systems depicted in FIG. 1 can be combined and/or omitted.

In some implementations, the user profile(s) database 110A can include contextual data associated with a user of the client device 110 and/or other information related to a user of the client device 110. In some versions of those implementations, contextual data associated with a user of the client device 110 can include, for instance, a client device context (e.g., current or recent context) of the client device 110 and/or a user context of a user of the client device 110 (or an active user of the client device 110 when the client device 110 is associated with multiple users). The contextual data stored in the client device database 110A can include, for example, client device data that characterizes current or recent interaction(s) of the client device 110 and/or a user of the client device 110, location data that characterizes a current or recent location(s) of the client device 110 and/or a geographical region associated with a user of the client device 110, user attribute data that characterizes one or more attributes of a user of the client device 110, user preference data that characterizes one or more preferences of a user of the client device 110, user profile data that characterizes a profile of a user of the client device 110, and/or any other data accessible via the client device 110A or otherwise.

For example, the client device 110 can determine a current context based on a current state of a conversation (e.g., considering one or more recent inputs provided by a user of the client device 110 and/or an additional user), profile data, and/or a current location of the client device 110. For instance, the client device 110 can determine a current context of “documents in common between [user of the client device 110] and [an additional user]” based on an ongoing conversation between a chatbot and the additional user, content of spoken utterance(s) during the conversation, and/or calendar information of the user of the client device 110. As another example, the client device 110 can determine a current context based on a command provided by a user of the client device 110 to initiate a conversation with an additional user that includes an identity of the additional user, that includes a task to be performed in engaging in the conversation with the additional user, and/or other information, such that the current context can include any information relevant to the conversation to be conducted with the additional user. Notably, a context determined by the client device 110 can be utilized, for example, in supplementing or rewriting generative model inputs as described herein, in performing a retrieval augmented generation (RAG) process to obtain certain electronic document(s) and/or other information (e.g., calendar information, location information, inventory information, etc.) that are relevant to the conversation, and/or in other manners that in furtherance of a chatbot engaging in the conversation with the additional user.

Moreover, the client device 110 can execute the generative chatbot system client 113. An instance of the generative chatbot system client 113 can be an application that is separate from an operating system of the client device 110 (e.g., installed “on top” of the operating system)—or can alternatively be implemented directly by the operating system of the client device 110. The generative chatbot system client 113 can communicate with the generative chatbot system 120 via one or more of the networks 199 (e.g., as shown in FIG. 1). It should be understood that the generative chatbot system client 113 can implement the generative chatbot system 120 locally at the client device 110 via the generative chatbot system client 113. However, it should also be understood that one or more aspects of the generative chatbot system 120 can be implemented remotely from the client device 110 (e.g., exclusively at a high-performance server or cluster of high-performance servers), or both remotely the generative chatbot system 120 and locally the client device 110 (e.g., via the generative chatbot system client 113) in a distributed manner.

Furthermore, the client device 110 and/or the generative chatbot system 120 may include one or more memories for storage of data and software applications, one or more processors for accessing data and executing the software applications, and other components that facilitate communication over one or more of the networks 199. In some implementations, one or more of the software applications can be installed locally at the client device 110, whereas in other implementations one or more of the software applications can be hosted remotely from the client device 110 (e.g., by one or more servers), but accessible by the client device 110 over one or more of the networks 199.

Although FIG. 1 is described with respect to a single client device having a single user, it should be understood that is for the sake of example and is not meant to be limiting. For example, one or more additional client devices of the user of the client device 110 can also implement the techniques described herein. For instance, the client device 110, the one or more additional client devices, and/or any other computing devices of the user can form an ecosystem of devices that can employ techniques described herein. These additional client devices and/or computing devices may be in communication with the client device 110 and/or the generative chatbot system 120 (e.g., over the one or more networks 199). As another example, a given client device can be utilized by multiple users in a shared setting (e.g., a group of users, a household, etc.).

As described herein, a chatbot can be a generative model (GM) based chatbot that corresponds to one or more GMs. A GM can be any sequence-to-sequence based machine learning model capable of generating generative vision data, generative audio data, generative textual data, and/or other forms of generative data. Some non-limiting examples of sequence-to-sequence based machine learning models that are capable of generating one or more forms of the generative data noted above include transformer-based machine learning models (e.g., encoder-decoder transformer models, encoder-only transformer models, decoder-only transformer models, etc. that optionally employ an attention mechanism or some other form of memory), stable diffusion-based machine learning models, recurrent neural network-based machine learning models, generative adversarial network-based machine learning models, etc. Various sequence-to-sequence based machine learning models have demonstrated multimodal capabilities in that they are capable of processing inputs in various modalities (e.g., text-based inputs, vision-based inputs, audio-based inputs, etc.) and generating outputs in various modalities (e.g., text-based output, vision-based outputs, audio-based generative outputs, etc.). Some particular non-limiting examples of these sequence-to-sequence based machine learning models that have demonstrated multimodal capabilities include the Gemini family of models, the ChatGPT family of models, the Claude family of models, the Llama family of models, and/or other families of sequence-to-sequence generative models.

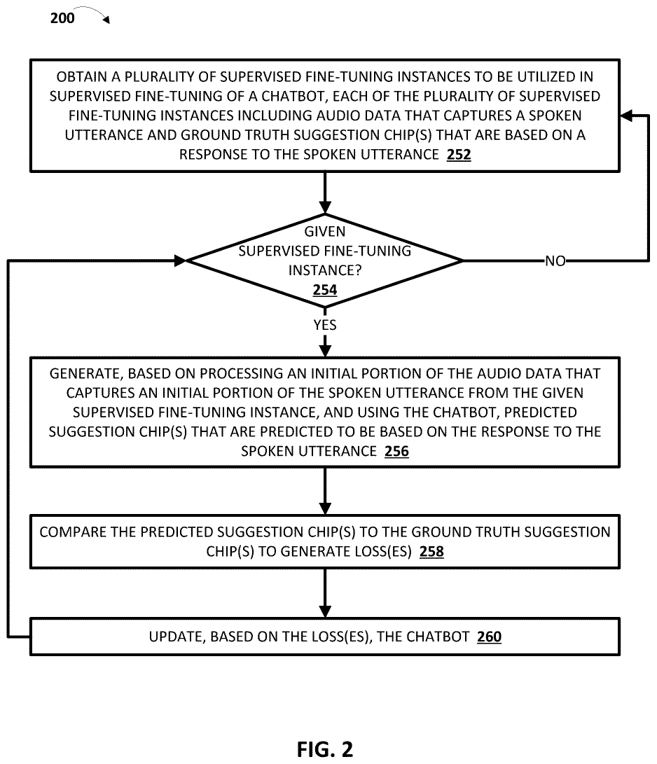

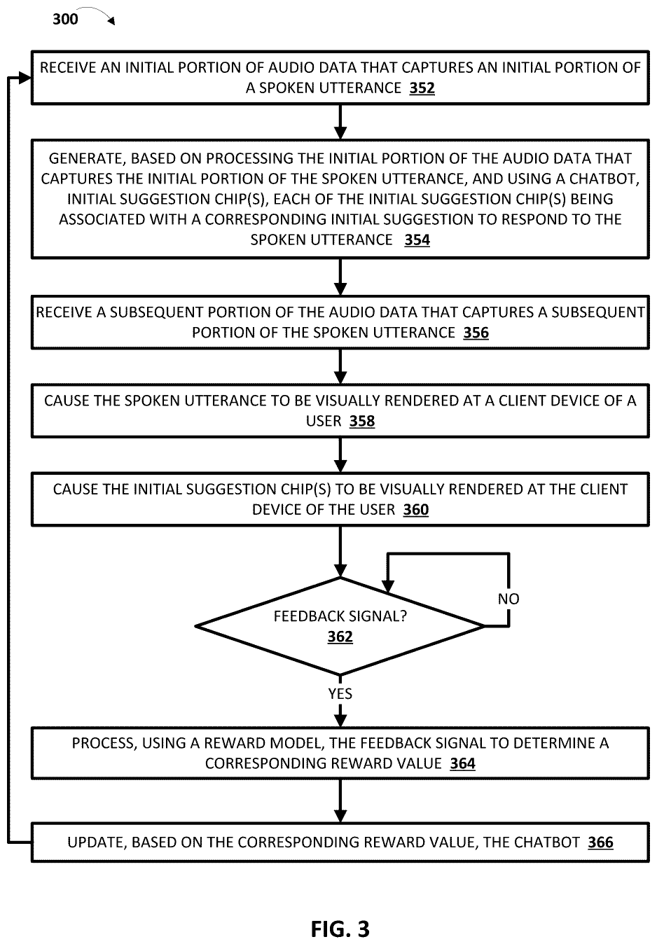

As described in more detail herein, the generative chatbot system 120 can be utilized to fine-tune a GM based chatbot using SFT (e.g., as described in more detail in FIG. 2). For example, the GM based chatbot can be fine-tuned using SFT to enable the GM based chatbot to generate initial suggestion chip(s), that are predicted to be responsive to a spoken utterance received during a telephone call, and based on an initial portion of the spoken utterance. Additionally, or alternatively, the GM based chatbot can be fine-tuned by performing RLHF (e.g., as described in more detail in FIG. 3). For example, the GM based chatbot can be fine-tuned using RLHF based on a human evaluating initial suggestion chip(s) generated using the GM based chatbot, that are predicted to be responsive to a spoken utterance received during a telephone call, and based on an initial portion of the spoken utterance. Additionally, or alternatively, prompt engineering techniques can be utilized in lieu of SFT and/or RLHF to cause the GM based chatbot to generate initial suggestion chip(s), that are predicted to be responsive to a spoken utterance received during a telephone call, and based on an initial portion of the spoken utterance.

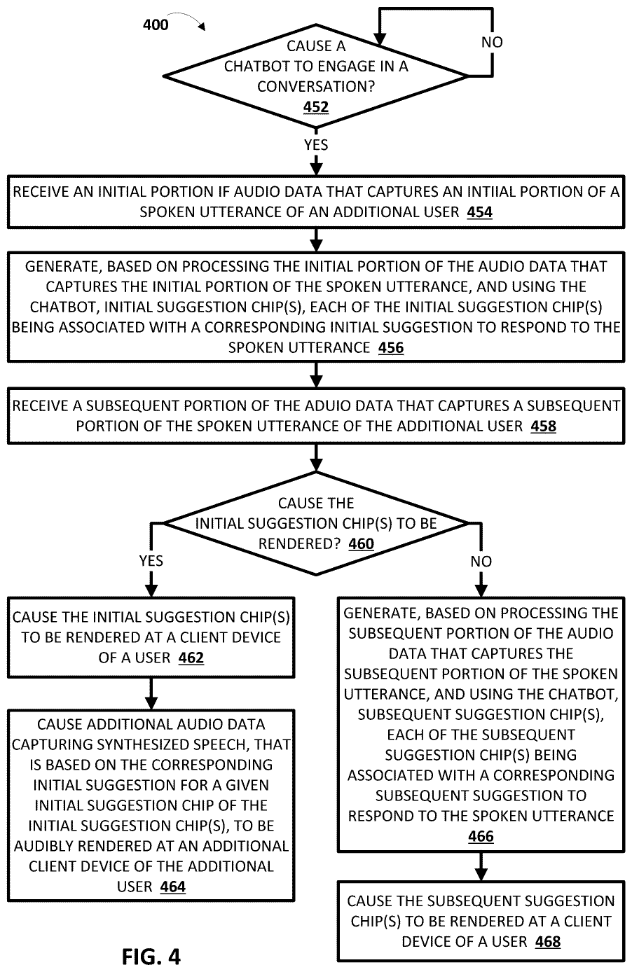

By using the SFT, RLHF, and/or prompt engineering techniques described herein, at inference, the generative chatbot system 120 can be configured to engage in a conversation, on behalf of the user of the client device 110, with an additional user during a telephone call. In engaging in the conversations, the GM based chatbot can generate initial suggestion chip(s), that are predicted to be responsive to a spoken utterance received during the telephone call, and from the additional user, based on processing an initial portion of the spoken utterance. Upon receiving a subsequent portion of the spoken utterance, the GM based chatbot can determine whether to render the initial suggestion chip(s) as corresponding suggested response(s) to the spoken utterance or to generate and render subsequent suggestion chip(s) that are generated based on both the initial portion of the spoken utterance and the subsequent portion of the spoken utterance (e.g., as described in more detail in FIG. 4). Put another way, the initial suggestion chip(s) can be generated based on the initial portion of the spoken utterance but prior to the spoken utterance being completed the additional user. If the initial suggestion chip(s) are responsive to the spoken utterance, upon receiving the subsequent portion of the spoken utterance, the initial suggestion chip(s) can be rendered at the client device 110, thereby reducing latency in causing the initial suggestion chip(s) to be rendered and concluding the telephone call in a more quick and efficient manner. However, if the initial suggestion chip(s) are not responsive to the spoken utterance, upon receiving the subsequent portion of the spoken utterance, the subsequent suggestion chip(s) can be generated and rendered at the client device 110.

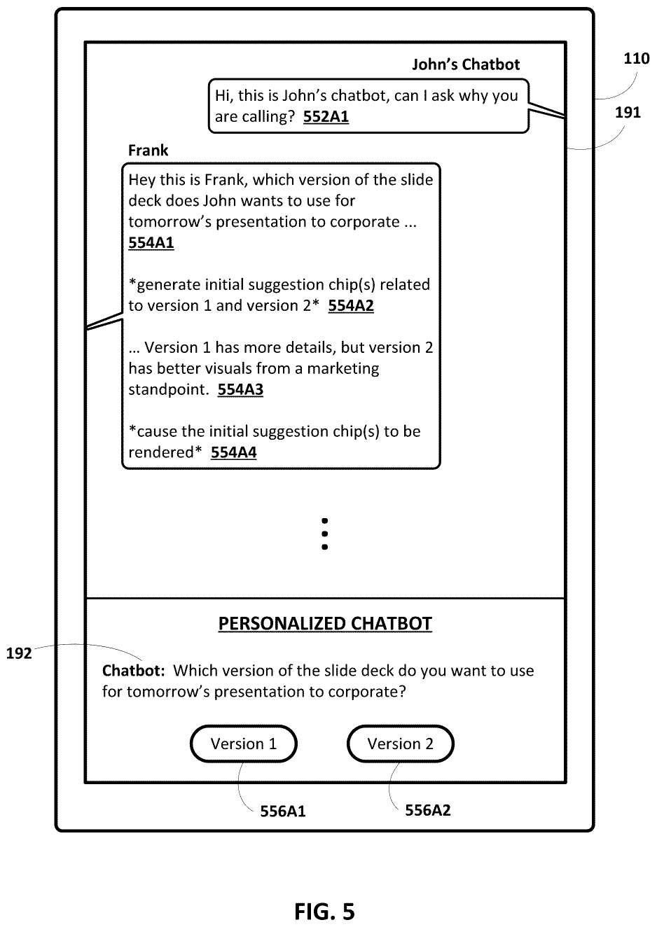

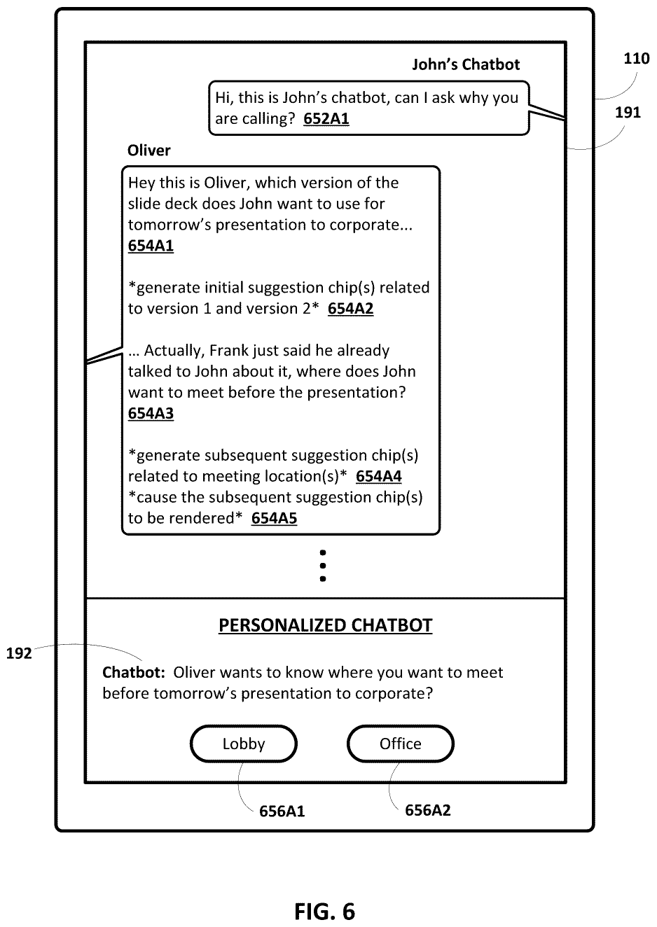

Notably, if the user of the client device 110 does not select a given one of the initial suggestion chip(s) or subsequent suggestion chip(s), the generative chatbot system 120 can automatically select a given one of the initial suggestion chip(s) or subsequent suggestion chip(s), thereby concluding the telephone call in a more quick and efficient manner. As a result of these techniques, computational and/or network resources can be conserved. Some non-limiting examples of this functionality is described in more detail in FIGS. 5 and 6. Additional description of the chatbot SFT engine 130, the chatbot RLHF engine 140, the chatbot inference engine 150, the suggestion chip generation engine 160, the suggestion chip modification engine 170, and the suggestion chip rendering engine 180 is provided herein (e.g., with respect to FIGS. 2, 3, 4, 5, and 6).

In some implementations, the conversations described herein can be conducted via a telephone call. In some versions of those implementations, the telephone call can be an outgoing telephone call initiated by a user of the client device 110, with an additional user, and based on user input detected at the client device 110 via the user input engine 111. For example, the user of the client device 110 can provide user input that includes a command to initiate the telephone call and, in response to receiving the command, the generative chatbot system client 113 and/or the generative chatbot system 120 can initiate the telephone call with the additional user of one of the additional client device(s) 197. In additional or alternative versions of those implementations, the telephone call can be an incoming telephone call that is directed at the client device 110 and initiated by the additional user of one of the additional client device(s) 197. For example, the additional user of one of the additional client device(s) 197 can initiate the telephone call and the generative chatbot system client 113 and/or the generative chatbot system 120 can answer the telephone call and engage in a conversation with the additional user of one of the additional client device(s) 197. Although the above implementations are described with respect to the conversation being telephone calls, it should be understood that is for the sake of example and is not meant to be limiting. For example, it should be understood that the conversations can also be, for example, conducted via other communication channels, such as Short Message Service (SMS) messaging, social media messaging, email messaging, software application messaging, and/or other forms of audio-based communications, text-based communications, vision-based communications, etc.

As noted above, in some implementations, the generative chatbot system 120 can be implemented remotely from the client device 110 and may be utilized in engaging in the conversations described herein. Put another way, even though telephone call(s) and/or other communications can be initiated from the client device 110 or directed to the client device 110, the generative chatbot system 120 can be utilized to engage in the conversation on behalf of the user of the client device 110 and in a cloud-based manner. However, in additional or alternative implementations, the generative chatbot system 120 can be implemented locally at the client device 110 via the generative chatbot system client 113 and may be utilized in engaging in the conversations described herein. Put another way, the generative chatbot system 120 can be utilized to engage in the conversation on behalf of the user of the client device 110 locally at the client device 110 and in an on-device manner.

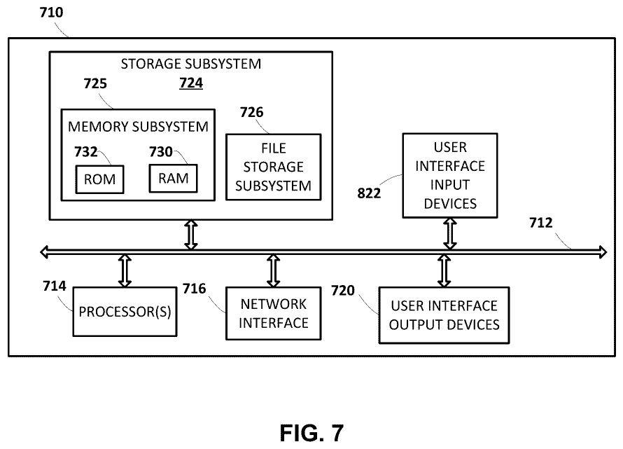

Turning now to FIG. 2, a flowchart illustrating an example method 200 of supervised fine-tuning (SFT) of a chatbot to enable generation of suggestion chip(s) during a telephone call is depicted. For convenience, the operations of the method 200 are described with reference to a system that performs the operations. This system of the method 200 includes at least one processor, memory, and/or other component(s) of computing device(s) (e.g., the client device 110 of FIG. 1, generative chatbot system 120 of FIG. 1, computing device 710 of FIG. 7, and/or other computing device.). Moreover, while operations of the method 200 are shown in a particular order, this is not meant to be limiting. One or more operations may be reordered, omitted, and/or added.

At block 252, the system obtains a plurality of SFT fine-tuning instances, each of the plurality of SFT fine-tuning instances including audio data that captures a spoken utterance and ground truth suggestion chip(s) that are based on a response to the spoken utterance. For example, the system can cause the chatbot SFT instance engine 131 of the chatbot SFT engine 130 to obtain the plurality of SFT fine-tuning instances from SFT instance(s) database 130A. In some implementations, one or more of the plurality of SFT fine-tuning instances may be based on conversations of a particular user (e.g., a user of the client device of FIG. 1), whereas in additional or alternative implementations, one or more of the plurality of SFT fine-tuning instances may be based on conversations of a plurality of users (e.g., a general corpus of conversations). Put another way, each of the plurality of SFT fine-tuning instances can be based on at least two turns of a conversation. Notably, the ground truth suggestion chip(s) are based on the response to the spoken utterance as opposed to the spoken utterance itself and may not include the entirety of the response to the spoken utterance. For example, the ground truth suggestion chip(s) can include a text snippet (e.g., a short summary) of the response to the spoken utterance. In situations where the ground truth suggestion chip(s) do not include the entirety of the response to the spoken utterance, a textual representation of the response to the spoken utterance and/or the entirety of the response to the spoken utterance may be utilized to generate the ground truth suggestion chip(s). Although block 252 is described with respect to obtaining the plurality of SFT fine-tuning instances from the SFT instance(s) database 130A, it should be understood that is for the sake of example and is not meant to be limiting. For example, the chatbot SFT instance engine 131 can generate one or more of the plurality of SFT fine-tuning instances.

At block 254, the system determines whether there is a given SFT fine-tuning instance in the plurality of SFT fine-tuning instances. If, at an iteration of block 254, the system determines that there is not a given SFT fine-tuning instance in the plurality of SFT fine-tuning instances, then the system returns to block 252. If, at an iteration of block 254, the system determines there is a given SFT fine-tuning instance in the plurality of SFT fine-tuning instances, the system proceeds to block 256. Notably, at an initial iteration of the operations of block 254, the system should determine that there is a given SFT fine-tuning instance in the plurality of SFT fine-tuning instances since the system obtained the plurality of SFT fine-tuning instances at block 252. However, at subsequent iterations of the operations of block 254, the system may determine that there is not a given SFT fine-tuning instance in the plurality of SFT fine-tuning instances and need to return to block 252 to obtain a plurality of additional SFT fine-tuning instances.

At block 256, the system generates, based on processing an initial portion of the audio data that captures an initial portion of the spoken utterance from the given SFT fine-tuning instance, and using the chatbot, predicted suggestion chip(s) that are predicted to be based on the response to the spoken utterance. For example, the system can cause the chatbot SFT processing engine 132 of the chatbot SFT engine 130 to generate the predicted suggestion chip(s) and based on processing the initial portion of the audio data that captures the initial portion of the spoken utterance from the given SFT fine-tuning instance. In some implementations, and in generating the predicted suggestion chip(s), the chatbot SFT processing engine 132 can process the initial portion of the audio data that captures the initial portion of the spoken utterance to predict a subsequent portion of the spoken utterance, and then generate the predicted suggestion chip(s) based on the initial portion of the spoken utterance and the predicted subsequent portion of the spoken utterance. For instance, assume that the spoken utterance is “we have availability for that day and time for the reservation, but we also need to know how many people will be joining the reservation and what type of seating you would prefer”. In this instance, the chatbot SFT processing engine 132 can process audio data capturing the initial portion of the spoken utterance of “we have availability for that day and time for the reservation, but” to predict the subsequent portion of the spoken utterance and then generate the predicted suggestion chip(s) based on the initial portion of the spoken utterance and the predicted subsequent portion of the spoken utterance. In additional or alternative implementations, and in generating the predicted suggestion chip(s), the chatbot SFT processing engine 132 can process the initial portion of the audio data that captures the initial portion of the spoken utterance to generate the predicted suggestion chip(s) without predicting the subsequent portion of the spoken utterance. Continuing with the above instance, the chatbot SFT processing engine 132 can process audio data capturing the initial portion of the spoken utterance of “we have availability for that day and time for the reservation, but” and generate the predicted suggestion chip(s) based on the initial portion of the spoken utterance.

At block 258, the system compares the predicted suggestion chip(s) to the ground truth suggestion chip(s) to generate one or more losses. At block 260, the system updates, based on one or more of the losses, the chatbot. For example, the system can cause the chatbot SFT update engine 133 of the chatbot SFT engine 130 to compare the predicted suggestion chip(s) to the ground truth suggestion chip(s) to generate the one or more losses, and then cause the chatbot SFT update engine 133 to update the chatbot based on the one or more losses (e.g., using backpropagation or other model training techniques). The system returns to block 254 and proceeds with an additional iteration of the method 200 to continue to fine-tune the chatbot based on additional SFT fine-tuning instance(s). For instance, the chatbot SFT update engine 133 could use a cosine similarity metric to compare a corresponding embedding for the predicted suggestion chip(s) to a corresponding embedding for the ground truth suggestion chip(s) to generate the one or more losses. Alternatively, the chatbot SFT update engine 133 could use a Jaccard similarity metric to compare the predicted suggestion chip(s) to the ground truth suggestion chip(s) by considering the overlap of words or n-grams between the predicted suggestion chip(s) and the ground truth suggestion chip(s). Alternatively, the chatbot SFT update engine 133 could calculate an edit distance (e.g., Levenshtein distance) between the predicted suggestion chip(s) and ground truth suggestion chip(s).

Continuing with the above instance where the spoken utterance is “we have availability for that day and time for the reservation, but we also need to know how many people will be joining the reservation and what type of seating you would prefer”, the ground truth suggestion chip(s) can include a suggestion chip related to party size and a suggestion chip related to a type of seating at the restaurant. Further, the predicted suggestion chip(s) can include one or more of a suggestion chip related to party size, a suggestion chip related to a type of seating at the restaurant, a suggestion chip related to potential allergies of persons attending the reservation, a suggestion chip related to whether children will be joining the reservation, a suggestion chip related to whether any disabilities need to be accommodated for the reservation, and so on. In this instance, the chatbot SFT update engine 133 of the chatbot SFT engine 130 can compare the predicted suggestion chip(s) to the ground truth suggestion chip(s) using one or more of the aforementioned techniques to generate the one or more losses and cause the chatbot to be updated based on the one or more losses.

Although the method 200 of FIG. 2 is described with respect to performing SFT to further improve the chatbot, it should be understood that SFT is not required. For instance, in some implementations, RLHF (e.g., as described with respect to FIG. 3) may be sufficient to produce meaningful outputs from the chatbot and the operations of FIG. 2 may be omitted. Also, for instance, in some implementations, prompt engineering may be sufficient to produce meaningful outputs from the chatbot and the operations of FIG. 2 and FIG. 3 may be omitted. In implementations where prompt engineering is utilized, a developer associated with the system can craft prompts that explicitly instruct the chatbot to generate suggestion chip(s) based on only the initial portion of an utterance as it is received. In these implementations, the need for the training data in block 252 is eliminated. Block 254 is bypassed as the prompt engineering approach doesn't require iterative refinement through multiple training instances. Block 256 is directly addressed by the prompt itself, which specifies the desired output format (suggestion chips). Blocks 258 and 260 are also unnecessary because there is no comparison to ground truth data or model updates and the chatbot's output is directly used. The prompt could include instructions on the desired number and type of suggestion chips, as well as contextual information to guide the chatbot's response. For example, a prompt could be: “Based on the following initial portion of a user utterance, generate three concise suggestion chips for a chatbot to respond with: [initial portion of utterance].” Different prompts can be tested to optimize the quality and relevance of the generated suggestion chips.

Turning now to FIG. 3, a flowchart illustrating an example method 300 of performing reinforcement learning from human feedback (RLHF) for a chatbot to enable generation of suggestion chip(s) during a telephone call is depicted. For convenience, the operations of the method 300 are described with reference to a system that performs the operations. This system of the method 300 includes at least one processor, memory, and/or other component(s) of computing device(s) (e.g., the client device 110 of FIG. 1, generative chatbot system 120 of FIG. 1, computing device 710 of FIG. 7, and/or other computing device.). Moreover, while operations of the method 300 are shown in a particular order, this is not meant to be limiting. One or more operations may be reordered, omitted, and/or added.

At block 352, the system receives an initial portion of audio data that captures an initial portion of a spoken utterance. For example, the system can cause the chatbot RLHF engine 140 to obtain the initial portion of the spoken utterance. In some implementations, the initial portion of the audio data that captures the spoken utterance can be from conversations of a particular user (e.g., from a user of the client device of FIG. 1), whereas in additional or alternative implementations, the initial portion of the audio data that captures the spoken utterance can be from a conversation between random users (e.g., from a general corpus of conversations). Put another way, the initial portion of the audio data that captures the spoken utterance can be from a conversation that includes at least two turns of dialog. Notably, the spoken utterance is not limited to those received during a telephone call

At block 354, the system generates, based on processing the initial portion of the audio data that captures the spoken utterance, and using a chatbot, initial suggestion chip(s), each of the initial suggestion chip(s) being associated with a corresponding initial suggestion to respond to the spoken utterance. In some implementations, and in generating the initial suggestion chip(s), the system can process the initial portion of the audio data that captures the initial portion of the spoken utterance to predict a subsequent portion of the spoken utterance, and then generate the initial suggestion chip(s) based on the initial portion of the spoken utterance and the predicted subsequent portion of the spoken utterance. For instance, assume that the spoken utterance is “we have availability for that day and time for the reservation, but we also need to know how many people will be joining the reservation and what type of seating you would prefer”. In this instance, the system can process audio data capturing the initial portion of the spoken utterance of “we have availability for that day and time for the reservation, but” to predict the subsequent portion of the spoken utterance and then generate the initial suggestion chip(s) based on the initial portion of the spoken utterance and the predicted subsequent portion of the spoken utterance. In additional or alternative implementations, and in generating the predicted suggestion chip(s), the system can process the initial portion of the audio data that captures the initial portion of the spoken utterance to generate the initial suggestion chip(s) without predicting the subsequent portion of the spoken utterance. Continuing with the above instance, the system can process audio data capturing the initial portion of the spoken utterance of “we have availability for that day and time for the reservation, but” and generate the initial suggestion chip(s) based on the initial portion of the spoken utterance.

At block 356, the system receives a subsequent portion of the audio data that captures a subsequent portion of the spoken utterance. For example, the system can cause the chatbot RLHF engine 140 to obtain the subsequent portion of the spoken utterance. Notably, the subsequent portion of the audio data that captures the subsequent portion of the spoken utterance is a continuation of the initial audio data that captures the initial portion of the spoken utterance, such that the initial audio data that captures the initial portion of the spoken utterance and the subsequent portion of the audio data that captures the subsequent portion of the spoken utterance correspond to audio data capturing an entirety of the spoken utterance.

At block 358, the system causes the spoken utterance to be visually rendered at a client device of a user. Notably, the entirety of the spoken utterance can be visually rendered at the client device. For example, the system can cause the chatbot RLHF engine 140 to cause a transcript corresponding to the spoken utterance to be visually rendered via a display of the client device of the user. The user can be, for example, an end user during an inference stage as described herein, a developer or Mechanical Turk that is associated with the system during an RLHF training stage as described herein, and/or other users.

At block 360, the system causes the initial suggestion chip(s) to be visually rendered at the client device of the user. Notably, although the entirety of the spoken utterance can be visually rendered at the client device, the initial suggestion chip(s) were only generated based on the initial portion of the spoken utterance. For example, the system can cause the chatbot RLHF engine 140 to cause the initial suggestion chip(s) to be visually rendered via the display of the client device of the user. In some implementations, the spoken utterance can be rendered at a first portion of the display of the client device and the initial suggestion chip(s) can be rendered at a second portion of the display of the client device, where the first portion of the display of the client device is visually distinct from the second portion of the display of the client device. In additional or alternative implementations, the initial suggestion chip(s) can be rendered at a same portion of the display of the client device at which the spoken utterance is rendered (e.g., in-line with the spoken utterance).

At block 362, the system determines whether a feedback signal has been received. The feedback signal can be, for example, an indication of a selection of one of the initial suggestion chip(s) that indicates the selected one of the suggestion chip(s) is associated with a suggested response that is responsive to the spoken utterance, an indication of a “thumbs up” signal that indicates the initial suggestion chip(s) (or a subset thereof) are responsive to the spoken utterance, an indication of a “thumbs down” signal that indicates the initial suggestion chip(s) (or a subset thereof) are not responsive to the spoken utterance, and/or other types of feedback signals that can have varying degrees of granularity with respect to the initial suggestion chip(s) as a whole or a subset thereof. If, at an iteration of block 362, the system determines that no feedback signal has been received, then the system continues monitoring for the feedback signal at block 362. If, at an iteration of block 362, the system determines that the feedback signal has been received, the system proceeds to block 364.

At block 364, the system processes, using a reward model, the feedback signal to determine a corresponding reward value. At block 366, the system updates, based on the corresponding reward value, the chatbot. For example, the chatbot RLHF engine 140 can utilize a reward model (e.g., stored in the reward model(s) database 140A) to process the feedback signal to determine the corresponding reward value and then cause the chatbot RLHF engine 140 to update the chatbot based on the corresponding reward value (e.g., using backpropagation or other model training techniques). For instance, assume that the feedback signal is a “thumbs up” signal that indicates the initial suggestion chip(s) (or a subset thereof) are responsive to the spoken utterance. In this instance, the chatbot RLHF engine 140 can process the “thumbs up” signal using a reward model to determine a “positive” reward value and then update the chatbot based on the “positive” reward value. Also, for instance, assume that the feedback signal is a “thumbs down” signal that indicates the initial suggestion chip(s) (or a subset thereof) are not responsive to the spoken utterance. In this instance, the chatbot RLHF engine 140 can process the “thumbs down” signal using a reward model to determine a “negative” reward value and then update the chatbot based on the “negative” reward value. Notably, the corresponding reward value can be used to update the chatbot's parameters, improving its ability to generate effective suggestion chips in future conversations. This iterative process refines the chatbot's performance through reinforcement learning. The system returns to block 352 and proceeds with an additional iteration of the method 300 of FIG. 3.

Although the method 300 of FIG. 3 is described with respect to performing RLHF to further improve the chatbot, it should be understood that RLHF is not required. For instance, in some implementations, SF (e.g., as described with respect to FIG. 2) may be sufficient to produce meaningful outputs from the chatbot and the operations of FIG. 3 may be omitted. Also, for instance, in some implementations, prompt engineering may be sufficient to produce meaningful outputs from the chatbot and the operations of FIG. 2 and FIG. 3 may be omitted. In implementations where prompt engineering is utilized, a developer associated with the system can craft prompts that explicitly instruct the chatbot to generate suggestion chip(s) based on only the initial portion of an utterance as it is received. In these implementations, the need for the feedback signal is eliminated and, as a result, the need for RLHF can be eliminated.

Turning now to FIG. 4, a flowchart illustrating an example method 400 of causing a chatbot to engage in a conversation during a telephone call and generate suggestion chip(s) during the telephone call is depicted. For convenience, the operations of the method 400 are described with reference to a system that performs the operations. This system of the method 400 includes at least one processor, memory, and/or other component(s) of computing device(s) (e.g., the client device 110 of FIG. 1, generative chatbot system 120 of FIG. 1, computing device 710 of FIG. 7, and/or other computing device.). Moreover, while operations of the method 400 are shown in a particular order, this is not meant to be limiting. One or more operations may be reordered, omitted, and/or added.

At block 452, the system determines whether to cause, on behalf of a user, a chatbot to engage in a conversation with an additional user during a telephone call. In some implementations, the system can determine to cause the chatbot to engage in the conversation with the additional user based on an incoming telephone call, that was initiated by the additional user, being directed to a client device of the user. In additional or alternative implementations, the system can determine to cause the chatbot to engage in the conversation with the additional user based on an outgoing telephone call, that was initiated by the user (or the chatbot based on a command provided by the user), being directed to an additional client device of the additional user. If, at an iteration of block 452, the system determines not to cause the chatbot to engage in the conversation with the additional user, then the system continues monitoring for whether to cause the chatbot to engage in the conversation with the additional user at block 452. If, at an iteration of block 452, the system determines to cause the chatbot to engage in the conversation with the additional user during the telephone call, then the system proceeds to block 454.

Although the above implementations are described with respect to the conversation occurring during an incoming telephone call and/or an outgoing telephone call, it should be understood that is for the sake of example and is not meant to be limiting. For example, it should be understood that the conversation can also be, for example, conducted via other communication channels, such as Short Message Service (SMS) messaging, social media messaging, email messaging, and/or other forms of audio-based communications, text-based communications, vision-based communications, etc.

At block 454, the system receives an initial portion of audio data that captures an initial portion of a spoken utterance of the additional user. For example, in implementations where the conversation is conducted during a telephone call (e.g., an incoming telephone call or outgoing telephone call), the initial portion of the audio data that captures the initial portion of the spoken utterance of the additional user can be generated via microphone(s) of an additional client device of the additional user, and received by the system over network(s) (e.g., network(s) 199 of FIG. 1). However, in implementations where the conversation is conducted via other communications channels, user inputs can be captured in other forms, such as textual forms, but include the same content as the spoken utterance of the additional user and the user inputs in these other forms can be processed in the same or similar manner as the audio data described herein.

At block 456, the system generates, based on processing the initial portion of the audio data that captures the initial portion of the spoken utterance, and using the chatbot, initial suggestion chip(s), each of the initial suggestion chip(s) being associated with a corresponding initial suggestion to respond to the spoken utterance. For example, the system can cause the chatbot input engine 151 of the chatbot inference engine 150 to generate generative model input that includes at least the initial portion of the audio data that captures the initial portion of the spoken utterance (e.g., the raw audio data that captures the initial portion of the spoken utterance) or the initial portion of the spoken utterance (e.g., text corresponding to the initial portion of the spoken utterance generated using an automatic speech recognition (ASR) model). In some implementations, the generative model input can optionally further include any prior spoken utterances of the conversation, any contextual data that is associated with the user and/or the additional user, an instruction to generate a predicted subsequent portion of the spoken utterance that is predicted to correspond to a subsequent portion of the spoken utterance that follows the initial portion of the spoken utterance, an instruction to generate initial suggestion chip(s) that are each associated with a corresponding initial suggestion for responding to the spoken utterance given only the initial portion of the spoken utterance (and optionally the predicted subsequent portion of the spoken utterance), and/or any additional information that may aid the chatbot in generating the initial suggestion chip(s).

Further, the system can cause the chatbot processing engine 152 of the chatbot inference engine 150 to process, using the chatbot, the generative model input to generate generative model output that includes one or more probability distributions over a corresponding sequence of tokens. Moreover, the system can cause the chatbot output engine 153 of the chatbot inference engine 150 to process the generative model output to decode the one or more probability distributions over the corresponding sequence of tokens (e.g., using one or more decoding techniques).

For instance, in some implementations, the generative model output can include a first probability distribution over a first sequence of tokens that is associated a predicted subsequent portion of the spoken utterance that is predicted to correspond to a subsequent portion of the spoken utterance that follows the initial portion of the spoken utterance, a second probability distribution over a second sequence of tokens that is associated with a corresponding predicted initial suggestions for responding to the spoken utterance based on which the initial suggestion chip(s) are generated, and/or a third probability distribution over a third sequence of tokens that is associated with the initial suggestion chip(s).

However, in additional or alternative implementations, the generative model output can include a single probability distribution over a sequence of tokens that is associated with a predicted subsequent portion of the spoken utterance that is predicted to correspond to a subsequent portion of the spoken utterance that follows the initial portion of the spoken utterance. Put another way, in these additional or alternative implementations, the generative model output may only include the predicted subsequent portion of the spoken utterance that is generated based on the initial portion of the suggestion chip(s), but not include any of the initial suggestion chip(s).

Further, in additional or alternative implementations, the generative model output can include a single probability distribution over a sequence of tokens that is associated with a corresponding predicted initial suggestions for responding to the spoken utterance based on which the initial suggestion chip(s) are generated. Put another way, in these additional or alternative implementations, the generative model output may not attempt to predict the subsequent portion of the spoken utterance that follows the initial portion of the spoken utterance and the initial suggestion chip(s) are generated based on the corresponding predicted initial suggestions for responding to the spoken utterance.

Lastly, in additional or alternative implementations, the generative model output can include a single probability distribution over a sequence of tokens that is associated with the initial suggestion chip(s). Put another way, in these additional or alternative implementations, the generative model output may not attempt to predict the subsequent portion of the spoken utterance that follows the initial portion of the spoken utterance or the corresponding predicted initial suggestions for responding to the spoken utterance, and the initial suggestion chip(s) are generated based on processing at least the initial portion of the spoken utterance.

Notably, in implementations where the generative model output does not include a probability distribution over a sequence of tokens that is associated with the initial suggestion chip(s), the suggestion chip generation engine 160 can generate the initial suggestion chip(s) based on the initial portion of the spoken utterance and the predicted subsequent portion of the spoken utterance if the predicted subsequent portion of the spoken utterance is generated at block 456. Additionally or alternatively, in implementations where the generative model output does not include a probability distribution over a sequence of tokens that is associated with the initial suggestion chip(s), the suggestion chip generation engine 160 can generate the initial suggestion chip(s) based on the initial portion of the spoken utterance and the corresponding predicted initial suggestions for responding to the spoken utterance if the corresponding predicted initial suggestions for responding to the spoken utterance are generated at block 456. Accordingly, it should be understood that various techniques for generating the initial suggestion chip(s) are contemplated herein.

At block 458, the system receives a subsequent portion of the audio data that captures a subsequent portion of the spoken utterance. Notably, the subsequent portion of the audio data that captures the subsequent portion of the spoken utterance is a continuation of the initial portion of the spoken utterance, and the subsequent portion of the spoken utterance can be received via a same communications channel (e.g., a telephonic communications channel, a SMS communications channel), a same form (e.g., audio data, text, etc.), and so on.

At block 460, the system determines whether to cause the initial suggestion chip(s) to be rendered at a client device of the user. The system can cause the suggestion chip modification engine 170 to determine whether to cause the initial suggestion chip(s) to be rendered at the client device of the user based on, for example, processing the subsequent portion of the audio data that captures the subsequent portion of the spoken utterance. For example, the suggestion chip modification engine 170 can cause the chatbot input engine 151 of the chatbot inference engine 150 to generate additional generative model input that includes at least the subsequent portion of the audio data that captures the subsequent portion of the spoken utterance subsequent portion of the spoken utterance. In some implementations, the additional generative model input can optionally further include any prior spoken utterances of the conversation, any contextual data that is associated with the user and/or the additional user, the initial portion of the audio data that captures the initial portion of the spoken utterance or the initial portion of the spoken utterance, the initial suggestion chip(s), the predicted subsequent portion of the subsequent spoken utterance if the predicted subsequent portion of the spoken utterance if the predicted subsequent portion of the spoken utterance is generated at block 456, the corresponding predicted initial suggestions for responding to the spoken utterance are generated at block 456, an instruction to determine whether to render the initial suggestion chip(s) given the subsequent portion of the spoken utterance, and/or any additional information that may aid the chatbot in determining whether to render the initial suggestion chip(s).

For instance, in some implementations, the additional generative model input can include: (i) the initial portion of the audio data that captures the initial portion of the spoken utterance or the initial portion of the spoken utterance, (ii) the subsequent portion of the audio data that captures the subsequent portion of the spoken utterance or the subsequent portion of the spoken utterance, and (iii) the initial suggestion chip(s). In this instance, the suggestion chip modification engine 170 can cause the chatbot processing engine 152 of the chatbot inference engine 150 to process, using the chatbot, the additional generative model input to generate additional generative model output that includes one or more probability distributions over a corresponding sequence of tokens. Further, the suggestion chip modification engine 170 can cause the chatbot output engine 153 of the chatbot inference engine 150 to process the additional generative model output to decode the one or more probability distributions over the corresponding sequence of tokens (e.g., using one or more decoding techniques), and determine, based on the additional generative model output, whether to cause the initial suggestion chip(s) to be rendered at the client device of the user. In this instance, the additional generative model output can include, for example, an indication of whether the initial suggestion chip(s) should be rendered, an indication of a subset of the initial suggestion chip(s) that should be rendered, and/or other information that can be used to determine whether to cause the initial suggestion chip(s) to be rendered.

However, in additional or alternative implementations, the additional generative model input can include: (i) the predicted subsequent portion of the spoken utterance if the predicted subsequent portion of the spoken utterance is generated at block 456, and (ii) the subsequent portion of the audio data that captures the subsequent portion of the spoken utterance or the subsequent portion of the spoken utterance. In this instance, the suggestion chip modification engine 170 can cause the chatbot processing engine 152 of the chatbot inference engine 150 to process, using the chatbot, the additional generative model input to generate additional generative model output that includes one or more probability distributions over a corresponding sequence of tokens. Further, the suggestion chip modification engine 170 can cause the chatbot output engine 153 of the chatbot inference engine 150 to process the additional generative model output to decode the one or more probability distributions over the corresponding sequence of tokens (e.g., using one or more decoding techniques), and determine, based on the additional generative model output, whether to cause the initial suggestion chip(s) to be rendered at the client device of the user. In this instance, the additional generative model output can include, for example, an indication of whether the predicted subsequent portion of the spoken utterance is sufficiently similar to the subsequent portion of the spoken utterance to cause the initial suggestion chip(s) to be rendered. This can include, for example, determining a similarity metric (e.g., a cosine similarity metric, a Jaccard similarity metric, an edit distance (e.g., Levenshtein distance), and/or other type of metric) between the predicted subsequent portion of the spoken utterance and the subsequent portion of the spoken utterance and determining to cause the initial suggestion chip(s) to be rendered in response to determining that the similarity metric satisfies a similarity threshold.

If, at an iteration of block 460, the system determines to cause the initial suggestion chip(s) to be rendered at the client device of the user, then the system proceeds to block 462. Put another way, if the system determines that the initial suggestion chip(s), that are generated based on the initial portion of the spoken utterance, are responsive to the spoken utterance, then the system can determine to cause the initial suggestion chip(s) to be rendered at the client device of the user and the system can proceed to block 462. At block 462, the system causes the initial suggestion chip(s) to be rendered at the client device of the user. For example, the system can cause the suggestion chip rendering engine 180 to cause the initial suggestion chip(s) to be rendered at the client device of the user. Notably, the initial suggestion chip(s) can be visually rendered via a display of the client device of the user. In some implementations, the initial suggestion chip(s) can be rendered in-line with a transcript of the spoken utterance. In additional or alternative implementations, the initial suggestion chip(s) can be rendered at a portion of the display that is distinct from a portion of the display at which a transcript of the spoken utterance is rendered.

At block 464, the system causes additional audio data capturing synthesized speech, that is based on the corresponding initial suggestion for a given initial suggestion chip of the initial suggestion chip(s), to be rendered at an additional client device of the additional user. In some implementations, the system can cause the additional audio data capturing the synthesized speech, that is based on the corresponding initial suggestion for the given initial suggestion chip of the initial suggestion chip(s), to be transmitted to the additional client device and rendered at the additional client device of the additional user based on receiving an indication of a selection of the given initial suggestion chip. The selection can be based on, for example, user input directed to the client device of the user, such as a touch selection directed to the given initial suggestion chip, a voice selection direction to the given initial suggestion chip, and so on. In some versions of those implementations, the system can process, using a text-to-speech (TTS) model, the corresponding initial suggestion for the given initial suggestion chip to generate the additional audio data capturing the synthesized speech. However, in additional or alternative versions of those implementations, and based on audio generation capabilities of the generative model based chatbot, the additional audio data may have been generated along with the initial suggestion chip(s) and, in these implementations, the system can obtain the additional audio data capturing the synthesized speech that is based on the corresponding initial suggestion for the given initial suggestion chip of the initial suggestion chip(s), and further cause the additional audio data to be rendered at the additional client device of the additional user.

In additional or alternative implementations, the system can cause the additional audio data capturing the synthesized speech, that is based on the corresponding initial suggestion for the given initial suggestion chip of the initial suggestion chip(s), to be rendered at the additional client device of the additional user based on determining that a threshold duration of time has lapsed since the initial suggestion chip(s) were rendered at the client device of the user. For example, and based on no indication of the given initial suggestion chip of the initial suggestion chip(s) being received during the threshold duration of time, the system can automatically select a highest ranking suggestion chip as the given initial suggestion chip and cause the additional audio data capturing the synthesized speech, that is based on the corresponding initial suggestion for the given initial suggestion chip of the initial suggestion chip(s), to be transmitted to the additional client device and rendered at the additional client device of the additional user. In these implementations, the highest ranking suggestion chip can be based on, for example, one or more probability distributions over one or more sequences of tokens that were utilized in generating the initial suggestion chip(s) as described with respect to the operations of block 456. In some versions of those additional or alternative implementations, the system can utilize the TTS model to generate the additional audio data or the additional audio data that was generated by the generative model based chatbot as described above.

In some versions of those additional or alternative implementations, the threshold duration of time can be general to a plurality of additional users and can be defined by, for example, a developer associated with the system or the user of the client device. For example, the system can automatically select the given initial suggestion chip of the initial suggestion chip(s) after three seconds, five seconds, ten seconds have lapsed since the initial suggestion chip(s) were rendered if no indication of a selection of any of the initial suggestion chip(s) is received. In other versions of those additional or alternative implementations, the threshold duration of time can be dynamically determined based on the additional user. For example, the system can dynamically determine the threshold duration of time based on a speaking pace of the spoken utterance of the additional user, a historical speaking pace of the additional user in previous audio conversations, a determined mood or sentiment of the additional user, and/or based on other factors. For instance, if the speaking pace of the spoken utterance of the additional user is relatively slow, then the threshold duration of time can be longer than if the speaking pace of the spoken utterance of the additional user is relatively fast.

If, at an iteration of block 460, the system determines not to cause the initial suggestion chip(s) to be rendered at the client device of the user, then the system proceeds to block 466. Put another way, if the system determines that the initial suggestion chip(s), that are generated based on the initial portion of the spoken utterance, are not responsive to the spoken utterance, then the system can determine not to cause the initial suggestion chip(s) to be rendered at the client device of the user and the system can proceed to block 466. At block 466, the system generates, based on processing the subsequent portion of the audio data that captures the subsequent portion of the spoken utterance, and using the chatbot, subsequent suggestion chip(s), each of the subsequent suggestion chip(s) being associated with a corresponding subsequent suggestion to respond to the spoken utterance. The system can generate the subsequent suggestion chip(s) in the same or similar manner described with respect to the operations of block 456, but using additional generative model input that also includes the subsequent portion of the audio data that captures the subsequent portion of the spoken utterance or the subsequent portion of the spoken utterance. Accordingly, if the system determines that the initial suggestion chip(s) are not responsive to the spoken utterance, then the system can generate the subsequent suggestion chip(s) that consider the entirety of the spoken utterance provided by the additional user.

At block 468, the system causes the subsequent suggestion chip(s) to be rendered at the client device of the user. For example, the system can cause the suggestion chip rendering engine 180 to cause the subsequent suggestion chip(s) to be rendered at the client device of the user. Notably, the subsequent suggestion chip(s) can be visually rendered via a display of the client device of the user. In some implementations, the subsequent suggestion chip(s) can be rendered in-line with a transcript of the spoken utterance. In additional or alternative implementations, the subsequent suggestion chip(s) can be rendered at a portion of the display that is distinct from a portion of the display at which a transcript of the spoken utterance is rendered.

Although not depicted in FIG. 4 for the sake of brevity, the system can further cause additional audio data capturing synthesized speech, that is based on the corresponding subsequent suggestion for a given subsequent suggestion chip of the subsequent suggestion chip(s), to be rendered at an additional client device of the additional user. In the same or similar manner described with respect to block 464, the system can cause the additional audio data capturing the synthesized speech to be rendered at the additional client device of the additional user based on receiving an indication of a selection of the given subsequent suggestion chip and/or based on determining that a threshold duration of time has lapsed since the subsequent suggestion chip(s) were rendered. Subsequent to the operations of block 464 or block 468, the system can return to block 454 and perform an additional iteration of the method 400 of FIG. 4. Accordingly, techniques described herein enable the chatbot to generate the initial suggestion chip(s) in anticipation that they will be responsive to the entirety of the spoken utterance of the additional user even though they are only generated based on the initial portion of the spoken utterance. Assuming that the initial suggestion chip(s) are responsive to the entirety of the spoken utterance, the system can quickly and efficiently render the initial suggestion chip(s) upon conclusion of the spoken utterance, thereby reducing latency in causing the initial suggestion chip(s) to be rendered at the client device of the user which, in turn, can conclude the conversation in a more quick and efficient manner.

Turning now to FIG. 5, a non-limiting example of generating initial suggestion chip(s) based on an initial portion of a spoken utterance received during a telephone call and determining to render the initial suggestion chip(s) based on a subsequent portion of the spoken utterance received during the telephone call is depicted. FIG. 5 depicts a client device 110 (e.g., an instance of the client device 110 from FIG. 1) having a display 191. Although the client device 110 of FIG. 5 is depicted as a mobile phone, it should be understood that is not meant to be limiting. The client device 110 can be, for example, a stand-alone assistant device (e.g., with speaker(s) and/or a display), a laptop, a desktop computer, a wearable computing device (e.g., a smart watch, smart headphones, etc.), a vehicular computing device, a game console, and/or any other client device.

For the sake of example, assume that an incoming call is directed to the client device 110 of a user (e.g., “John”) and was initiated by an additional user (e.g., “Frank”) via an additional client device of the additional user, and that John's chatbot is configured to answer incoming telephone calls and, upon answering the incoming telephone call, renders audio data capturing synthesized speech 552A1 of “Hi, this is John's chatbot, can I ask why you are calling?” as part of the telephone call. Further assume that, in response to the synthesized speech 552A1, Frank begins providing a spoken utterance that includes a first portion 554A1 of “Hey this is Frank, which version of the slide deck does John want to use for tomorrow's presentation to corporate”. Notably, the first portion 554A1 of the spoken utterance can be captured in audio data and John's chatbot can generate initial suggestion chip(s) based on processing at least the first portion 554A1 of the spoken utterance. For instance, John's chatbot can generate the initial suggestion chip(s) based on processing the first portion 554A1 of the spoken utterance (or the audio data capturing the first portion 554A1 of the spoken utterance) and contextual data associated with John and/or Frank, such as electronic documents shared between John and Frank including “Version 1” of the slide deck referenced in the initial portion 554A1 of the spoken utterance and “Version 2” of the slide deck referenced in the initial portion 554A1 of the spoken utterance. Thus, and as indicated at 554A2, John's chatbot can generate the initial suggestion chip(s) based on at least the first portion 554A1 of the spoken utterance and the contextual data.

However, John's chatbot may refrain from causing the initial suggestion chip(s) to be rendered at the client device 110 since Frank has not yet finished providing the spoken utterance. Nonetheless, assume Frank continues providing the spoken utterance that includes a second portion 554A3 of “version 1 has more details, but version 2 has better visuals from a marketing standpoint.” Notably, the second portion 554A3 of the spoken utterance can be captured in audio data and John's chatbot can determine whether to cause the initial suggestion chip(s) to be rendered at the client device 110 based on processing at least the second portion 554A3 of the spoken utterance. For example, John's chatbot can additionally process at least the second portion 554A3 of the spoken utterance (or the audio data capturing the second portion 554A3 of the spoken utterance) to determine whether to cause the initial suggestion chip(s) to be rendered. In some implementations, John's chatbot can also process the first portion 554A1 of the spoken utterance (or the audio data capturing the first portion 554A1 of the spoken utterance) and/or the initial suggestion chip(s) to determine whether to cause the initial suggestion chip(s) to be rendered (e.g., as described with respect to the method 400 of FIG. 4). In additional or alternative implementations, John's chatbot can also process a predicted second portion of the spoken utterance that was predicted to correspond to the second portion 554A3 of the spoken utterance to determine whether to cause the initial suggestion chip(s) to be rendered (e.g., as also described with respect to the method 400 of FIG. 4).

Further assume that in the example of FIG. 5, John's chatbot determines to cause the initial suggestion chip(s) to be rendered at the client device 110 as indicated at 554A4. In this example, the initial suggestion chip(s) can include at least a first suggestion chip 556A1 and a second suggestion chip 556A2. For example, the first suggestion chip 556A1 can correspond to “Version 1” of the slide deck and the second suggestion chip 556A2 can correspond to “Version 2” of the slide deck. In some implementations, if John selects the first suggestion chip 556A1, then the client device 110 will cause additional audio data indicating they should use “Version 1” for the presentation and optionally additional detail that is responsive to the spoken utterance provided by Frank. However, if John selects the second suggestion chip 556A2, then the client device 110 will cause additional audio data indicating they should use “Version 2” for the presentation and optionally additional detail that is responsive to the spoken utterance provided by Frank. In additional or alternative implementations, if John does not select the first suggestion chip 556A1 or the second suggestion chip 556A2 (e.g., within a threshold duration of time of the initial suggestion chip(s) being rendered at the client device 110), then the client device 110 can automatically select, for example, the first suggestion chip 556A1 if it is the highest ranked suggestion chip, and cause the additional audio data indicating they should use “Version 1” for the presentation and optionally additional detail that is responsive to the spoken utterance provided by Frank.

Although a transcript of the telephone call is rendered at the display 191 of the client device 110 in FIG. 5, it should be understood that is for the sake of example and is not meant to be limiting. For example, the transcript of the telephone call may not be rendered at the display 191 of the client device 110 but instead may be visually rendered at an additional display of the client device 110, or may be rendered at an additional display of an additional device separate from the client device 110 (e.g., another mobile phone, a wearable computing device, etc.). Further, although the first suggestion chip 556A1 and the second suggestion chip 556A2 are rendered at the display 191 of the client device 110 in FIG. 5 in a portion of the display 191 that is distinct from a portion of the display 191 at which the transcript of the telephone call is rendered, it should be understood that is for the sake of example and is not meant to be limiting. For example, the first suggestion chip 556A1 and the second suggestion chip 556A2 can be rendered in-line with the transcript of the telephone call at the display 191. Moreover, although two suggestion chips (e.g., the first suggestion chip 556A1 and the second suggestion chip 556A2) are rendered at the display 191 of the client device 110 in FIG. 5, it should be understood that is for the sake of example and is not meant to be limiting. Rather, it should be understood that any suitable number of suggestion chip(s) can be rendered at the client device 110, but that a size of the display 191 can limit a number of them (e.g., when the client device 110 is a mobile device having a limited display size).

Turning now to FIG. 6, a non-limiting example of generating initial suggestion chip(s) based on an initial portion of a spoken utterance received during a telephone call and determining to generate and render subsequent suggestion chip(s) based on a subsequent portion of the spoken utterance received during the telephone call is depicted. FIG. 6 depicts a client device 110 (e.g., an instance of the client device 110 from FIG. 1) having a display 191. Although the client device 110 of FIG. 6 is depicted as a mobile phone, it should be understood that is not meant to be limiting. The client device 110 can be, for example, a stand-alone assistant device (e.g., with speaker(s) and/or a display), a laptop, a desktop computer, a wearable computing device (e.g., a smart watch, smart headphones, etc.), a vehicular computing device, a game console, and/or any other client device.

For the sake of example, again assume that an incoming call is directed to the client device 110 of a user (e.g., “John”) and was initiated by another additional user (e.g., “Oliver”) via another additional client device of the another additional user, and that John's chatbot is configured to answer incoming telephone calls and, upon answering the incoming telephone call, renders audio data capturing synthesized speech 652A1 of “Hi, this is John's chatbot, can I ask why you are calling?” as part of the telephone call. Further assume that, in response to the synthesized speech 652A1, Oliver begins providing a spoken utterance that includes a first portion 654A1 of “Hey this is Oliver, which version of the slide deck does John want to use for tomorrow's presentation to corporate”. Notably, the first portion 654A1 of the spoken utterance can be captured in audio data and John's chatbot can generate initial suggestion chip(s) based on processing at least the first portion 654A1 of the spoken utterance. For instance, John's chatbot can generate the initial suggestion chip(s) based on processing the first portion 654A1 of the spoken utterance (or the audio data capturing the first portion 654A1 of the spoken utterance) and contextual data associated with John and/or Oliver, such as electronic documents shared between John and Oliver including “Version 1” of the slide deck referenced in the initial portion 654A1 of the spoken utterance and “Version 2” of the slide deck referenced in the initial portion 654A1 of the spoken utterance. Thus, and as indicated at 654A2, John's chatbot can generate the initial suggestion chip(s) based on at least the first portion 654A1 of the spoken utterance and the contextual data.

However, John's chatbot may refrain from causing the initial suggestion chip(s) to be rendered at the client device 110 since Oliver has not yet finished providing the spoken utterance. Nonetheless, assume Oliver continues providing the spoken utterance that includes a second portion 654A3 of “actually, Frank just said he already talked to John about it, where does John want to meet before the presentation.” Notably, the second portion 654A3 of the spoken utterance can be captured in audio data and John's chatbot can determine whether to cause the initial suggestion chip(s) to be rendered at the client device 110 based on processing at least the second portion 654A3 of the spoken utterance. For example, John's chatbot can additionally process at least the second portion 654A3 of the spoken utterance (or the audio data capturing the second portion 654A3 of the spoken utterance) to determine whether to cause the initial suggestion chip(s) to be rendered. In some implementations, John's chatbot can also process the first portion 654A1 of the spoken utterance (or the audio data capturing the first portion 654A1 of the spoken utterance) and/or the initial suggestion chip(s) to determine whether to cause the initial suggestion chip(s) to be rendered (e.g., as described with respect to the method 400 of FIG. 4). In additional or alternative implementations, John's chatbot can also process a predicted second portion of the spoken utterance that was predicted to correspond to the second portion 654A3 of the spoken utterance to determine whether to cause the initial suggestion chip(s) to be rendered (e.g., as also described with respect to the method 400 of FIG. 4).

Further assume that in the example of FIG. 6, John's chatbot determines not to cause the initial suggestion chip(s) to be rendered at the client device 110 and instead determine to generate subsequent suggestion chip(s) as indicated at 654A4. In this example, the initial suggestion chip(s) may have been related to the version of the presentation to be utilized in the presentation and based on the first portion 654A1 of the spoken utterance (e.g., the first suggestion chip 556A1 and the second suggestion chip 556A2 as described with respect to FIG. 5). Nonetheless, John's chatbot can subsequent suggestion chip(s) based on processing at least the second portion 654A3 of the spoken utterance. For instance, John's chatbot can generate the subsequent suggestion chip(s) based on processing the second portion 654A3 of the spoken utterance (or the audio data capturing the second portion 654A3 of the spoken utterance) and contextual data associated with John and/or Oliver, such common locations of John and/or Oliver. Thus, and as indicated at 654A4, John's chatbot can generate the subsequent suggestion chip(s) based on at least the second portion 654A3 of the spoken utterance and the contextual data, and can cause the subsequent suggestion chip(s) to be rendered as indicated at 654A5.

In this example, the subsequent suggestion chip(s) can include at least a first suggestion chip 656A1 and a second suggestion chip 656A2. For example, the first suggestion chip 656A1 can correspond to “Lobby” of the corporate office and the second suggestion chip 656A2 can correspond to “Office” where John and Oliver's offices are located. In some implementations, if John selects the first suggestion chip 656A1, then the client device 110 will cause additional audio data indicating they should meet at the “Lobby” of the corporate office before the presentation and optionally additional detail that is responsive to the spoken utterance provided by Oliver, such as a suggested meeting time based on predicted time for travel, their respective schedules, and so on. However, if John selects the second suggestion chip 656A2, then the client device 110 will cause additional audio data indicating they should meet at their “Office” before the presentation and optionally additional detail that is responsive to the spoken utterance provided by Oliver, such as a suggested meeting time based on predicted time for travel, their respective schedules, and so on. In additional or alternative implementations, if John does not select the first suggestion chip 656A1 or the second suggestion chip 656A2 (e.g., within a threshold duration of time of the subsequent suggestion chip(s) being rendered at the client device 110), then the client device 110 can automatically select, for example, the first suggestion chip 656A1 if it is the highest ranked suggestion chip, and cause the additional audio data indicating they should meet at the “Lobby” of the corporate office before the presentation.

Although a transcript of the telephone call is rendered at the display 191 of the client device 110 in FIG. 6, it should be understood that is for the sake of example and is not meant to be limiting. For example, the transcript of the telephone call may not be rendered at the display 191 of the client device 110 but instead may be visually rendered at an additional display of the client device 110, or may be rendered at an additional display of an additional device separate from the client device 110 (e.g., another mobile phone, a wearable computing device, etc.). Further, although the first suggestion chip 656A1 and the second suggestion chip 656A2 are rendered at the display 191 of the client device 110 in FIG. 6 in a portion of the display 191 that is distinct from a portion of the display 191 at which the transcript of the telephone call is rendered, it should be understood that is for the sake of example and is not meant to be limiting. For example, the first suggestion chip 656A1 and the second suggestion chip 656A2 can be rendered in-line with the transcript of the telephone call at the display 191. Moreover, although two suggestion chips (e.g., the first suggestion chip 656A1 and the second suggestion chip 656A2) are rendered at the display 191 of the client device 110 in FIG. 6, it should be understood that is for the sake of example and is not meant to be limiting. Rather, it should be understood that any suitable number of suggestion chip(s) can be rendered at the client device 110, but that a size of the display 191 can limit a number of them (e.g., when the client device 110 is a mobile device having a limited display size).

Further, although the examples of FIGS. 5 and 6 are described with respect to the conversations being conducted during an incoming telephone call, it should be understood that is for the sake of example and is not meant to be limiting. For example, it should be understood that the techniques described herein can also be performed during a conversation that is conducted during an outgoing telephone call and/or conversations through other communication channels (e.g., SMS messaging, text messages, social networking messages, emails, etc.).

Moreover, although the examples of FIGS. 5 and 6 are described with respect to the suggestion chip(s) not being rendered during the conversations until the additional user has completed providing of the spoken utterance, it should be understood that is for the sake of example and is not meant to be limiting. For instance, in the example of FIG. 5, the first suggestion chip 556A1 and the second suggestion chip 556A2 can be rendered in response to being generated and prior to Frank finishing the spoken utterance. Also, for instance, in the example of FIG. 6, the initial suggestion chip(s) (e.g., the first suggestion chip 556A1 and the second suggestion chip 556A2 from FIG. 5) can be rendered in response to being generated and prior to Frank finishing the spoken utterance. However, in the example of FIG. 5, the initial suggestion chip(s) can be supplanted with the first suggestion chip 656A1 and the second suggestion chip 656A2 in response to receiving the second portion 654A3 of the spoken utterance.

Turning now to FIG. 7, a block diagram of an example computing device 710 that may optionally be utilized to perform one or more aspects of techniques described herein. In some implementations, one or more of a client device, remote system component(s), and/or other component(s) may comprise one or more components of the example computing device 710.

Computing device 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of the methods disclosed herein, as well as to implement various components depicted in FIG. 1.

These software modules are generally executed by processor 714 alone or in combination with other processors. Memory 725 used in the storage subsystem 724 can include a number of memories including a main random-access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem 712 may use multiple busses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by processor(s) is provided and includes causing, on behalf of a user, a chatbot to engage in a conversation with an additional user during a telephone call. During the telephone call, the method includes receiving an initial portion of audio data that captures an initial portion of a spoken utterance of the additional user. The method also includes generating, based on processing the initial portion of the audio data and using the chatbot, one or more initial suggestion chips. Each of these initial suggestion chips is associated with a corresponding initial suggestion to respond to the spoken utterance of the additional user. The method further includes receiving a subsequent portion of the audio data that captures a subsequent portion of the spoken utterance of the additional user. The method includes determining, based on processing the subsequent portion of the audio data, whether to cause the one or more initial suggestion chips to be rendered at a client device of the user. In response to determining to cause the one or more initial suggestion chips to be rendered at the client device of the user, the method includes causing the one or more initial suggestion chips to be rendered at the client device of the user. The method also includes causing additional audio data, capturing synthesized speech based on the corresponding initial suggestion for a given initial suggestion chip, to be audibly rendered at an additional client device of the additional user.

These and other implementations of technology disclosed herein can optionally include one or more of the following features.

In some implementations, the method can further include: receiving an indication of a selection of the given initial suggestion chip, of the one or more initial suggestion chips, the selection being based on user input directed to the client device of the user. Causing the additional audio data capturing the synthesized speech to be audibly rendered at the additional client device of the additional user can be in response to receiving the indication of the selection of the given initial suggestion chip.

In some versions of those implementations, the chatbot can be a generative model based chatbot, and causing the additional audio data capturing the synthesized speech to be audibly rendered at the additional client device of the additional user can include: processing, using a text-to-speech (TTS), text, that includes the corresponding initial suggestion for the given initial suggestion chip and that is generated by the generative model based chatbot, to generate the additional audio data capturing the synthesized speech; and transmitting, to the additional client device, the additional audio data capturing the synthesized speech.

In additional or alternative versions of those implementations, the chatbot can be a generative model based chatbot, and causing the additional audio data capturing the synthesized speech to be audibly rendered at the additional client device of the additional user can include: obtaining the additional audio data capturing the synthesized speech, the additional audio data being generated by the generative model based chatbot along with the given initial suggestion chip; and transmitting, to the additional client device, the additional audio data capturing the synthesized speech.

In some implementations, the method can further include: determining whether a threshold duration of time has lapsed since the one or more initial suggestion chips were rendered at the client device of the user. Causing the additional audio data capturing the synthesized speech to be audibly rendered at the additional client device of the additional user can be in response to determining the threshold duration of time has lapsed since the one or more initial suggestion chips were rendered at the client device of the user. The given initial suggestion chip can be automatically selected from among the one or more initial suggestion chips.

In some versions of those implementations, the chatbot can be a generative model based chatbot, and causing the additional audio data capturing the synthesized speech to be audibly rendered at the additional client device of the additional user can include: processing, using a text-to-speech (TTS), text, that includes the corresponding initial suggestion for the given initial suggestion chip and that is generated by the generative model based chatbot, to generate the additional audio data capturing the synthesized speech; and transmitting, to the additional client device, the additional audio data capturing the synthesized speech.

In additional or alternative versions of those implementations, the chatbot can be a generative model based chatbot, and causing the additional audio data capturing the synthesized speech to be audibly rendered at the additional client device of the additional user can include: obtaining the additional audio data capturing the synthesized speech, the additional audio data being generated by the generative model based chatbot along with the given initial suggestion chip; and transmitting, to the additional client device, the additional audio data capturing the synthesized speech.

In additional or alternative versions of those implementations, the method can further include, in response to determining the threshold duration of time has not lapsed since the one or more initial suggestion chips were rendered at the client device of the user: continuing monitoring for receiving an indication of a selection of the given initial suggestion chip, of the one or more initial suggestion chips.

In additional or alternative versions of those implementations, the threshold duration of time can be specific to the additional user, and the threshold duration of time can be based on: a speaking pace of the spoken utterance, or a historical speaking pace of the additional user.

In additional or alternative versions of those implementations, the threshold duration of time can be general to a plurality of additional users, including the additional user, and the threshold duration of time can be defined by: a developer that is associated with the chatbot, or the user.

In some implementations, generating the one or more initial suggestion chips based on processing the initial portion of the audio data that captures the initial portion of the spoken utterance of the additional user can include: processing, using the chatbot, generative model input to generate generative model output, the generative model input including at least the initial portion of the audio data that captures the initial portion of the spoken utterance of the additional user; and generating, based on the generative model output, the one or more initial suggestion chips.

In some versions of those implementations, the generative model input can further include an instruction to generate the corresponding initial suggestions to respond to the spoken utterance of the additional user.

In additional or alternative versions of those implementations, each of the one or more initial suggestions chips can be an identifier for the corresponding initial suggestion to respond to the spoken utterance of the additional user that includes less detail that content of the corresponding initial suggestion to respond to the spoken utterance of the additional user.

In additional or alternative versions of those implementations, generating the one or more initial suggestion chips based on the generative model output can include: determining, based on the generative model output, a predicted subsequent portion of the spoken utterance of the additional user that is predicted to correspond to the subsequent portion of the spoken utterance of the additional user; and generating, based on the predicted subsequent portion of the spoken utterance of the additional user that is predicted to correspond to the subsequent portion of the spoken utterance of the additional user, the one or more initial suggestion chips.

In some further additional or alternative versions of those implementations, determining whether to cause the one or more initial suggestion chips to be rendered at the client device of the user based on processing the subsequent portion of the audio data that captures the subsequent portion of the spoken utterance of the additional user can include: processing, using the chatbot, additional generative model input to generate generative model output, the additional generative model input including: the initial portion of the audio data that captures the initial portion of the spoken utterance, the subsequent portion of the audio data that captures the subsequent portion of the spoken utterance, and/or the one or more initial suggestion chips; and determining, based on the additional generative model output, whether to cause the one or more initial suggestion chips to be rendered at the client device of the user.

In yet further additional or alternative versions of those implementations, the generative model input can further include an instruction to determine whether the corresponding initial suggestion, for one or more of the initial suggestion chips, are responsive to the spoken utterance given both the initial portion of the audio data that captures the initial portion of the spoken utterance and the subsequent portion of the audio data that captures the subsequent portion of the spoken utterance, and wherein the additional generative model output is indicative of whether the corresponding initial suggestion, for one or more of the initial suggestion chips, are responsive to the spoken utterance given both the initial portion of the audio data that captures the initial portion of the spoken utterance and the subsequent portion of the audio data that captures the subsequent portion of the spoken utterance.

In other further additional or alternative versions of those implementations, determining whether to cause the one or more initial suggestion chips to be rendered at the client device of the user based on processing the subsequent portion of the audio data that captures the subsequent portion of the spoken utterance of the additional user can include: processing, using the chatbot, additional generative model input to generate generative model output, the additional generative model input including: the predicted subsequent portion of the spoken utterance of the additional user that is predicted to correspond to the subsequent portion of the spoken utterance of the additional user, and the subsequent portion of the spoken utterance of the additional user; determining, based on the additional generative model output, whether the predicted subsequent portion of the spoken utterance of the additional user satisfies a threshold similar measure with respect to the subsequent portion of the spoken utterance of the additional user; and in response to determining that the predicted subsequent portion of the spoken utterance of the additional user satisfies the threshold similar measure with respect to the subsequent portion of the spoken utterance of the additional user: causing the one or more initial suggestion chips to be rendered at the client device of the user.

In yet other further additional or alternative versions of those implementations, the method can further include, in response to determining that the predicted subsequent portion of the spoken utterance of the additional user does not satisfy the threshold similar measure with respect to the subsequent portion of the spoken utterance of the additional user: generating, based on processing at least the subsequent portion of the audio data that captures the subsequent portion of the spoken utterance of the additional user, one or more subsequent suggestion chips, each of the one or more subsequent suggestions chips being associated with a corresponding subsequent suggestion to respond to the spoken utterance of the additional user; and causing the one or more subsequent suggestion chips to be rendered at the client device of the user.

In some implementations, the method can further include, in response to determining to refrain from causing the one or more initial suggestion chips to be rendered at the client device of the user: generating, based on processing at least the subsequent portion of the audio data that captures the subsequent portion of the spoken utterance of the additional user, one or more subsequent suggestion chips, each of the one or more subsequent suggestions chips being associated with a corresponding subsequent suggestion to respond to the spoken utterance of the additional user; and causing the one or more subsequent suggestion chips to be rendered at the client device of the user.

In some versions of those implementations, the method can further include: causing additional audio data capturing synthesized speech, that is based on the corresponding subsequent suggestion for a given subsequent suggestion chip of the one or more subsequent suggestion chips, to be audibly rendered at an additional client device of the additional user.

In some further versions of those implementations, the method can further include: receiving an indication of a selection of the given subsequent suggestion chip, of the one or more subsequent suggestion chips, the selection being based on user input directed to the client device of the user. Causing the additional audio data capturing the synthesized speech to be audibly rendered at the additional client device of the additional user can be in response to receiving the indication of the selection of the given subsequent suggestion chip.

In some additional or alternative further versions of those implementations, the method can further include: determining whether a threshold duration of time has lapsed since the one or more subsequent suggestion chips were rendered at the client device of the user. Causing the additional audio data capturing the synthesized speech to be audibly rendered at the additional client device of the additional user can be in response to determining the threshold duration of time has lapsed since the one or more subsequent suggestion chips were rendered at the client device of the user.

In some implementations, causing the one or more initial suggestion chips to be rendered at the client device of the user can be in response to determining that the additional user has completed the spoken utterance.

In some implementations, the method can further include causing a transcript of the telephone call to be rendered at the client device of the user. The transcript of the telephone call can be rendered via a first portion of a display of the client device of the user, the one or more initial suggestion chips can be rendered via a second portion of the display of the client device of the user, and the second portion of the display of the client device of the user can be visually distinguishable from the first portion of the display of the client device of the user.

In some implementations, causing the chatbot to engage in the conversation with the additional user during the telephone call and on behalf of the user can include: receiving an indication of user input that is directed to the client device of the user and that includes a request to initiate an outgoing telephone call with the additional user; and in response to receiving the indication of the user input that is directed to the client device of the user and that includes the request to initiate the outgoing telephone call with the additional user: causing the chatbot to initiate the outgoing telephone call, as the telephone call, with the additional user; and causing the chatbot to engage in the conversation with the additional user during the outgoing telephone call.

In some implementations, causing the chatbot to engage in the conversation with the additional user during the telephone call and on behalf of the user can include: receiving an indication of an incoming telephone call that is directed to the client device of the user and that was initiated by the additional user; and in response to receiving the indication of the incoming telephone call that is directed to the client device of the user and that was initiated by the additional user: causing the chatbot to answer the incoming telephone call, as the telephone call, with the additional user; and causing the chatbot to engage in the conversation with the additional user during the incoming telephone call.

In some implementations, the chatbot can be a generative model based chatbot, and the generative model based chatbot can be executed locally at the client device of the user.

In some implementations, the chatbot can be a generative model based chatbot, and the generative model based chatbot can be executed remotely from the client device of the user.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform operations of any of the aforementioned methods. Some implementations also include a computer program product including instructions executable by one or more processors to perform operations of any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
causing, on behalf of a user, a chatbot to engage in a conversation with an additional user during a telephone call; and
during the telephone call:
receiving an initial portion of audio data that captures an initial portion of a spoken utterance of the additional user;
generating, based on processing the initial portion of the audio data that captures the initial portion of the spoken utterance of the additional user, and using the chatbot, one or more initial suggestion chips, each of the one or more initial suggestions chips being associated with a corresponding initial suggestion to respond to the spoken utterance of the additional user;
receiving a subsequent portion of the audio data that captures a subsequent portion of the spoken utterance of the additional user;
determining, based on processing the subsequent portion of the audio data that captures the subsequent portion of the spoken utterance of the additional user, whether to cause the one or more initial suggestion chips to be rendered at a client device of the user; and
in response to determining to cause the one or more initial suggestion chips to be rendered at the client device of the user:
causing the one or more initial suggestion chips to be rendered at the client device of the user; and
causing additional audio data capturing synthesized speech, that is based on the corresponding initial suggestion for a given initial suggestion chip of the one or more initial suggestion chips, to be audibly rendered at an additional client device of the additional user.

2. The method of claim 1, further comprising:
receiving an indication of a selection of the given initial suggestion chip, of the one or more initial suggestion chips, the selection being based on user input directed to the client device of the user,
wherein causing the additional audio data capturing the synthesized speech to be audibly rendered at the additional client device of the additional user is in response to receiving the indication of the selection of the given initial suggestion chip.

3. The method of claim 2, wherein the chatbot is a generative model based chatbot, and wherein causing the additional audio data capturing the synthesized speech to be audibly rendered at the additional client device of the additional user comprises:
processing, using a text-to-speech (TTS), text, that includes the corresponding initial suggestion for the given initial suggestion chip and that is generated by the generative model based chatbot, to generate the additional audio data capturing the synthesized speech; and
transmitting, to the additional client device, the additional audio data capturing the synthesized speech.

4. The method of claim 2, wherein the chatbot is a generative model based chatbot, and wherein causing the additional audio data capturing the synthesized speech to be audibly rendered at the additional client device of the additional user comprises:
obtaining the additional audio data capturing the synthesized speech, the additional audio data being generated by the generative model based chatbot along with the given initial suggestion chip; and
transmitting, to the additional client device, the additional audio data capturing the synthesized speech.

5. The method of claim 1, further comprising:
determining whether a threshold duration of time has lapsed since the one or more initial suggestion chips were rendered at the client device of the user,
wherein causing the additional audio data capturing the synthesized speech to be audibly rendered at the additional client device of the additional user is in response to determining the threshold duration of time has lapsed since the one or more initial suggestion chips were rendered at the client device of the user, and
wherein the given initial suggestion chip is automatically selected from among the one or more initial suggestion chips.

6. The method of claim 5 wherein the chatbot is a generative model based chatbot, and wherein causing the additional audio data capturing the synthesized speech to be audibly rendered at the additional client device of the additional user comprises:
processing, using a text-to-speech (TTS), text, that includes the corresponding initial suggestion for the given initial suggestion chip and that is generated by the generative model based chatbot, to generate the additional audio data capturing the synthesized speech; and
transmitting, to the additional client device, the additional audio data capturing the synthesized speech.

7. The method of claim 5, wherein the chatbot is a generative model based chatbot, and wherein causing the additional audio data capturing the synthesized speech to be audibly rendered at the additional client device of the additional user comprises:
obtaining the additional audio data capturing the synthesized speech, the additional audio data being generated by the generative model based chatbot along with the given initial suggestion chip; and
transmitting, to the additional client device, the additional audio data capturing the synthesized speech.

8. The method of claim 5, further comprising:
in response to determining the threshold duration of time has not lapsed since the one or more initial suggestion chips were rendered at the client device of the user:
continuing monitoring for receiving an indication of a selection of the given initial suggestion chip, of the one or more initial suggestion chips.

9. The method of claim 5, wherein the threshold duration of time is specific to the additional user, and wherein the threshold duration of time is based on: a speaking pace of the spoken utterance, or a historical speaking pace of the additional user.

10. The method of claim 5, wherein the threshold duration of time is general to a plurality of additional users, including the additional user, and wherein the threshold duration of time is defined by: a developer that is associated with the chatbot, or the user.

11. The method of claim 1, wherein generating the one or more initial suggestion chips based on processing the initial portion of the audio data that captures the initial portion of the spoken utterance of the additional user comprises:
processing, using the chatbot, generative model input to generate generative model output, the generative model input including at least the initial portion of the audio data that captures the initial portion of the spoken utterance of the additional user; and
generating, based on the generative model output, the one or more initial suggestion chips.

12. The method of claim 11, wherein the generative model input further includes an instruction to generate the corresponding initial suggestions to respond to the spoken utterance of the additional user.

13. The method of claim 11, wherein each of the one or more initial suggestions chips is an identifier for the corresponding initial suggestion to respond to the spoken utterance of the additional user that includes less detail that content of the corresponding initial suggestion to respond to the spoken utterance of the additional user.

14. The method of claim 11, wherein generating the one or more initial suggestion chips based on the generative model output comprises:
determining, based on the generative model output, a predicted subsequent portion of the spoken utterance of the additional user that is predicted to correspond to the subsequent portion of the spoken utterance of the additional user; and
generating, based on the predicted subsequent portion of the spoken utterance of the additional user that is predicted to correspond to the subsequent portion of the spoken utterance of the additional user, the one or more initial suggestion chips.

15. The method of claim 14, wherein determining whether to cause the one or more initial suggestion chips to be rendered at the client device of the user based on processing the subsequent portion of the audio data that captures the subsequent portion of the spoken utterance of the additional user comprises:
processing, using the chatbot, additional generative model input to generate generative model output, the additional generative model input including: the initial portion of the audio data that captures the initial portion of the spoken utterance, the subsequent portion of the audio data that captures the subsequent portion of the spoken utterance, and/or the one or more initial suggestion chips; and
determining, based on the additional generative model output, whether to cause the one or more initial suggestion chips to be rendered at the client device of the user.

16. The method of claim 15, wherein the generative model input further includes an instruction to determine whether the corresponding initial suggestion, for one or more of the initial suggestion chips, are responsive to the spoken utterance given both the initial portion of the audio data that captures the initial portion of the spoken utterance and the subsequent portion of the audio data that captures the subsequent portion of the spoken utterance, and wherein the additional generative model output is indicative of whether the corresponding initial suggestion, for one or more of the initial suggestion chips, are responsive to the spoken utterance given both the initial portion of the audio data that captures the initial portion of the spoken utterance and the subsequent portion of the audio data that captures the subsequent portion of the spoken utterance.

17. The method of claim 14, wherein determining whether to cause the one or more initial suggestion chips to be rendered at the client device of the user based on processing the subsequent portion of the audio data that captures the subsequent portion of the spoken utterance of the additional user comprises:
processing, using the chatbot, additional generative model input to generate generative model output, the additional generative model input including: the predicted subsequent portion of the spoken utterance of the additional user that is predicted to correspond to the subsequent portion of the spoken utterance of the additional user, and the subsequent portion of the spoken utterance of the additional user;
determining, based on the additional generative model output, whether the predicted subsequent portion of the spoken utterance of the additional user satisfies a threshold similar measure with respect to the subsequent portion of the spoken utterance of the additional user; and
in response to determining that the predicted subsequent portion of the spoken utterance of the additional user satisfies the threshold similar measure with respect to the subsequent portion of the spoken utterance of the additional user:
causing the one or more initial suggestion chips to be rendered at the client device of the user.

18. The method of claim 17, further comprising:
in response to determining that the predicted subsequent portion of the spoken utterance of the additional user does not satisfy the threshold similar measure with respect to the subsequent portion of the spoken utterance of the additional user:
generating, based on processing at least the subsequent portion of the audio data that captures the subsequent portion of the spoken utterance of the additional user, one or more subsequent suggestion chips, each of the one or more subsequent suggestions chips being associated with a corresponding subsequent suggestion to respond to the spoken utterance of the additional user; and
causing the one or more subsequent suggestion chips to be rendered at the client device of the user.

19. A system comprising:
at least one processor; and
memory storing instructions that, when executed by the at least one processor, cause the at least one processor to be operable to:
cause, on behalf of a user, a chatbot to engage in a conversation with an additional user during a telephone call; and
during the telephone call:
receive an initial portion of audio data that captures an initial portion of a spoken utterance of the additional user;
generate, based on processing the initial portion of the audio data that captures the initial portion of the spoken utterance of the additional user, and using the chatbot, one or more initial suggestion chips, each of the one or more initial suggestions chips being associated with a corresponding initial suggestion to respond to the spoken utterance of the additional user;
receive a subsequent portion of the audio data that captures a subsequent portion of the spoken utterance of the additional user;
determine, based on processing the subsequent portion of the audio data that captures the subsequent portion of the spoken utterance of the additional user, whether to cause the one or more initial suggestion chips to be rendered at a client device of the user; and
in response to determining to cause the one or more initial suggestion chips to be rendered at the client device of the user:
cause the one or more initial suggestion chips to be rendered at the client device of the user; and
cause additional audio data capturing synthesized speech, that is based on the corresponding initial suggestion for a given initial suggestion chip of the one or more initial suggestion chips, to be audibly rendered at an additional client device of the additional user.

20. A non-transitory computer-readable storage medium storing instructions that, when executed by at least one processor, cause the at least one processor to execute the instructions to:
cause, on behalf of a user, a chatbot to engage in a conversation with an additional user during a telephone call; and
during the telephone call:
receive an initial portion of audio data that captures an initial portion of a spoken utterance of the additional user;
generate, based on processing the initial portion of the audio data that captures the initial portion of the spoken utterance of the additional user, and using the chatbot, one or more initial suggestion chips, each of the one or more initial suggestions chips being associated with a corresponding initial suggestion to respond to the spoken utterance of the additional user;
receive a subsequent portion of the audio data that captures a subsequent portion of the spoken utterance of the additional user;
determine, based on processing the subsequent portion of the audio data that captures the subsequent portion of the spoken utterance of the additional user, whether to cause the one or more initial suggestion chips to be rendered at a client device of the user; and
in response to determining to cause the one or more initial suggestion chips to be rendered at the client device of the user:
cause the one or more initial suggestion chips to be rendered at the client device of the user; and
cause additional audio data capturing synthesized speech, that is based on the corresponding initial suggestion for a given initial suggestion chip of the one or more initial suggestion chips, to be audibly rendered at an additional client device of the additional user.
